(19) United States
(12) Patent Application Publication
(10) Pub. No.: US 2021/0035043 A1
(43) Pub. Date: Feb. 4, 2021

(54) SYSTEM AND METHOD FOR EMPLOYEE TEAM-BASED PERFORMANCE ENHANCEMENT

(71) Applicant: PerformanceDelta, LLC, Madison, MS (US)

(72) Inventors: Christopher M. Burgess, Ridgeland, MS (US); John Thomas Pacillo, Johnstown, CO (US)

(21) Appl. No.: 16/969,067

(22) PCT Filed: Feb. 12, 2019
(86) PCT No.: PCT/US2019/017689

§ 371 Date: Aug. 11, 2020

Related U.S. Application Data
(60) Provisional application No. 62/629,640, filed on Feb. 12, 2018.

(51) Int. Cl. G06Q 10/06; G06F 9/54

(52) U.S. Cl. CPC G06Q 10/06393; G06F 9/541; G06Q 10/0637; G06Q 10/06398

(57) ABSTRACT

A system and method providing an new and enhanced employee team-based interactive performance system to a plurality of employee-players and having a plurality of performance teams within each of one or more performance leagues, a system user integrated employee-player management services and functions with new and enhanced employee interoperability and user interfaces providing and communications between a system user and a employee-player defined by the system user having a user resource manager (URM) resident on a computing device of a system user. The URM generating new features and functionality by providing league, team and player-client profile page generated data that is transmitted to use remote device for displaying reporting and success parameters, objective metric data and assigned points responsive to received metric data received by the URM including comparisons of newly generated performance data and generating rewards based on system established reward thresholds and comparisons.

### CROSS-REFERENCE TO RELATED APPLICATIONS

This application is a Patent Cooperation Treaty (PCT) International Application that claims the benefit of U.S. Provisional Application No. 62/629,640, filed on Feb. 12, 2018, the disclosure of which is fully incorporated herein by reference.

### FIELD

The present disclosure is directed to systems and methods providing employers the engagement of employees.

### BACKGROUND

The statements in this section merely provide background information related to the present disclosure and may not constitute prior art.

On average, only 34% of employees are engaged in the goals of the company. 49% of employees are not engaged (or indifferent) and 17% are actively disengaged. This is consistent across all generations, so it is not likely to change on its own. On average, disengaged employees are 20% less productive and 51% more likely to leave. There are no current systems or technical solutions available to companies that are technically designed to engage employees into the objective of the company or group of commonly focused companies other than mere data and parameter reporting systems such as a persons or organizations sales or revenues. None of the existing system can enable cross-organization teams that work together towards a common goal. The inventors hereof have recognized this problem and void of company support systems and have developed a new technical solution system and method for cross-organizational employee team engagement towards a company's objectives that engages each employee in a fun interactive environment.

### SUMMARY

The inventors hereof have succeeded at developing and system and method that provides for the engagement of not only the 34% but also the other 66% of an employer's employee workforce. The inventors developed a system and method for use by employers that provide new employee interactive methods using computer graphic user interfaces for enabling the employees to participate in team oriented systems based on predetermined goals and objectives, and the system determined thresholds and comparisons and algorithms. The new system and method determines and produces new employee user platforms and interfaces that are based on team competition that enable and drive employee engagement. The present system and method not only engages the top performer employee, but engages employees at every level of the employer organization (“client entity”) through the newly developed Performance Fantasy League (PFL) system (PFLS) and method (PFLM).

The herein disclosed PFL system PFLS and method of operation thereof leverages competition and teamwork in the employer organization that enables PFL employee groups as teams that are focused on employer success objectives, but that engages employees by creating a new fun method and system for the employees.

In one aspect, a system provides an integrated employee and employee-team performance management service that has a user resource manager (URM) resident on a computing device of a system user with a display and a communication interface. This system is composed of a plurality of resource modules that provide a graphical interface in the form of URM pages displayed on the system user computing device display. The system also includes employee-player computing device displays with each computing device having a communications interface that provides communications over a communications network to the communication device of each employee players. The URM includes a plurality of teams assigned to a league and has a team profile and a league profile, and has an employee-player profile for each employee-player. The system also has league defined reporting parameters and objective metric data, assignable points for at least some of the objective metric data, league defined employee-player team reward triggers, and predetermined performance rewards associated with each reward trigger. Each employee-player can be assigned to at least one team in the league and each employee-player profile includes employee-player profile parameters and employee-player reward triggers. The PFL URM is configured for receiving league, team and employee profile input including at least one reward trigger and points assigned to at least some of the predetermined objective metric data. It is further configured for receiving objective metric data from an external source that is associated with at least one of the employee-players. It is also configured for assigning predetermined points to the received objective metric data, and providing league, team and employee-player profile page displays. The PFL is further configured for transmitting to a remote employee-player device each of the league, team and employee-player displays and reporting parameters, the received objective metric data and the assigned points associated with the received objective metric data. The PFL is configured for comparing the received employee-player reporting data, assigning points to the reporting data, summing the total assigned points for an employee-player or for a team of the player and comparing the total assigned points to a predetermined reward trigger. From this, the system is configured for generating a reward output message awarding a predetermined performance reward to a player or a team upon a successful comparing that determines that the summed points is equal to or greater than the predetermined reward trigger for the predetermined reward identified in the reward output message.

In another aspect, a method provides an employee team-based performance system to a plurality of employee user players (users), in a plurality of performance teams within each of one or more performance leagues. The method includes operations in a remote device that has a employee-player user application interface communicatively interfacing to a plurality of remotely situated User Resource Manager (URM) applications. Each of these is associated with a different employee-player user, and a content services interface configured for communicating with one or more content servers with each content server providing objective metric data associated with at least one of the employee players. The method includes receiving at a system employee-player interface a plurality of employee-player reporting profiles for a particular employee-player user, wherein each employee-player reporting profile is for a different employee-player previously selected by the employee-player user and has one or more employee-player reporting parameters including at least an assignment of the employee-player to a teams in a league. The method also includes receiving from the content server employee-player data associated with at least one of the employee-player reporting parameters of a particular one of the employee-players metric data identifying an activity or event having objective metric data associated with the particular employee-player and the team and league to which the employee-player is assigned. Further the method includes transmitting at least a portion of the received employee-player metric data to the URM with which the employee-player profile is associated. The method also includes processes performed in the user resource manager (URM) resident on a computing device of each employee-player user having a display and a employee-player interface. This is composed of a plurality of resource modules that provide a graphical interface in the form of URM pages displayed on the employee-player user computing device display. The computing device has a communications interface that provides communications over a communications network to a communication device of each employee-player selected by the employee-player user of the URM. The URM includes the plurality of employee-player profiles with each employee-player profile being for one of the employee-players defined by the employee-player user and having one or more team parameters and one or more league parameters. Each league has one or more teams, and also has one or more employee-player parameters that includes one or more employee-player reporting parameters and one or more employee-player reward triggers. The method includes providing a plurality of league page displays as a part of the displayed URM pages, and providing a plurality of team page displays as a part of the displayed URM pages. Each team page is for a team to which the employee-player is a team member. The method includes providing a plurality of employee-player profile page displays as a part of the displayed URM pages. This method also includes transmitting to the remote device at least a portion of the employee-player profile for each employee-player as the employee-player reporting profile including the one or more employee-player reporting parameters. The method includes receiving the instant employee-player data from the remote device and updating the employee-player profile with the instant employee-player data. The method also includes comparing the received instant employee-player data with a employee-player reward trigger defined in the employee-player profile and detecting in near real time as a result of the comparing an occurrence of an reward event. The method also includes generating an alert action to a component of the computing device of the employee-player user providing an indication on the computing device that the reward event was detected as a result of the detecting.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a block flow chart of one exemplary embodiments of an employee performance fantasy league (PFL) incentive and performance system and method of system data store and processing modules and system inter-operational processing flows.

FIG. 2 is a hierarchical flow chart of the present data structure of the Performance Fantasy League (PFL) system and method according to one exemplary embodiment.

FIG. 3 is a relational flow chart of a PFL system and method according to one exemplary embodiment.

FIG. 4 is a block diagram of a PFL system and method illustrating the data interfaces of the system for receiving various data, the internal specialized processing, and the generation of the newly created PFL system and user presentations of the newly created data, according to one exemplary embodiment.

FIG. 5 is a block diagram of a PFL system and method illustrating a PFL process flows for establishing a PFL league, KPI metrics and PFL league scoring parameter, employee players in a PFL league and the PFL system generated player, league and company performance results according to one exemplary embodiment.

FIG. 6 is a screen shot of a webpage for a PFL system and method illustrating a webpage for presenting a PFL league overview dashboard for an entire established employee player and team league status information according to one exemplary embodiment.

FIG. 7 is a screen shot of a webpage for a PFL system and method illustrating a webpage for a team performance data as generated by the PFL system according to one exemplary embodiment.

FIG. 8 is a screen shot of a webpage for a PFL system and method illustrating a webpage for league match ups among various players in the league and the current player performance data and matchups scoreboard according to one exemplary embodiment.

FIG. 9 is a screen shot of a webpage for a PFL system and method illustrating a webpage for player standings presentation for players in a PFL league along with a scoreboard for those players in the league according to one exemplary embodiment.

FIG. 10 is a screen shot of a webpage for a PFL system and method illustrating a webpage for player profile presentation for players in a PFL league along with a performance history for those players in the league according to one exemplary embodiment.

FIG. 11 is a screen shot of a webpage for a PFL system and method illustrating a webpage for setting of points for a league that includes setting point scoring configurations to be used by the system and method for league, team, matchup and player scoring according to one exemplary embodiment.

FIG. 12 is a screen shot of a webpage for a PFL system and method illustrating the establishing of MVP settings in establishing a new PFL league, and the activation of a message board to enable message board functionality within the PFL system for PFL player communications according to one exemplary embodiment.

FIG. 13 is a mobile device screen shot of a webpage for a PFL system and method illustrating a webpage listing of an automated recap such as weekly or monthly of an individual player's personal performance statistics in a league, including standings, days earned points, trends, leaderboards and company goals according to one exemplary embodiment.

FIG. 14 is a screen shot of a webpage for a PFL system and method illustrating of an overview of one PFL player's PFL activities and scoring in the PFL leagues and a PFL calendar for past PFL player events according to one exemplary embodiment.

FIG. 15 is an image of a mobile device graphical user interface for a PFL system and method illustrating a player's mobile home page according to one exemplary embodiment.

FIG. 16 is an image of a mobile device graphical user interface for a PFL system and method illustrating for a PFL league a player's personal statistics as determined by the PFL system and method and identified player matchup results according to one exemplary embodiment.

FIG. 17 is an image of a mobile device graphical user interface for a PFL system and method illustrating the presentation of players standings in a PFL league based on points and ranking according to one exemplary embodiment.

FIG. 18 is an image of a mobile device graphical user interface for a PFL system and method illustrating a PFL league matchup and player performance in those matchups according to one exemplary embodiment.

FIG. 19 is an image of a mobile device graphical user interface for a PFL system and method illustrating a listing of PFL players and their standings in the PFL league and their current PFL league point totals according to one exemplary embodiment.

FIG. 20 is an image of a mobile device graphical user interface for a PFL system and method illustrating a PFL league player profile and PFL player performance history according to one exemplary embodiment.

FIG. 21 is a schematic block diagram illustrating one exemplary computer and telecommunications network environment suitable for use with a PFL system and method according to some exemplary embodiments.

FIG. 22 is a schematic block diagram illustrating one exemplary computer data storage and retrieval networking environment suitable for use with a PFL system and method according to some exemplary embodiments.

FIG. 23 is a schematic block diagram illustrating one exemplary computer operating environment communicating over a network suitable for use with a PFL system and method according to some exemplary embodiments.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In some embodiments, a PFL system provides an integrated employee and employee-team performance management service has a user resource manager (URM) resident on a computing device of a system user has a display and a communication interface and is composed of a plurality of resource modules provide a graphical interface in the form of URM pages displayed on the system user computing device display. The system also includes employee-player computing device displays with each computing device having a communications interface the provides communications over a communications network to the communication device of each employee-players. The URM includes a plurality of teams assigned to a league and has a team profile and a league profile, and has an employee-player profile for each employee-player. The system also has league defined reporting parameters and objective metric data, assignable points for at least some of the objective metric data, league defined employee-player team reward triggers, and predetermined performance rewards associated with each reward trigger. Each employee-player can be assigned to at least one team in the league and each employee-player profile includes employee-player profile parameters and employee-player reward triggers.

The PFL URM is configured for receiving league, team and employee profile input including at least one reward trigger and points assigned to at least some of the predetermined objective metric data and receiving objective metric data from an external source that is associated with at least one of the employee-players. It is further configured for assigning predetermined points to the received objective metric data, and providing league, team and employee-player profile page displays. The PFL is further configured for transmitting to a remote employee-player device each of the league, team and employee-player displays and reporting parameters, the received objective metric data and the assigned points associated with the received objective metric data, comparing the received employee-player reporting data, assigning points to the reporting data, summing the total assigned points for an employee-player or for a team of the player and comparing the total assigned points to a predetermined reward trigger. From this, the system is configured for generating a reward output message awarding a predetermined performance reward to a player or a team upon a successful comparing that determines that the summed points is equal to or greater than the predetermined reward trigger for the predetermined reward identified in the reward output message.

In another embodiment, a method provides an employee team-based performance system to a plurality of employee user players (users), and has a plurality of performance teams within each of one or more performance leagues. The method includes operations in a remote device has a employee-player user application interface communicatively interfacing to a plurality of remotely situated User Resource Manager (URM) applications, each is associated with a different employee-player user, and a content services interface configured for communicating with one or more content servers with each content server providing objective metric data associated with at least one of the employee players.

The method includes receiving at a system employee-player interface a plurality of employee-player reporting profiles for a particular employee-player user, the employee-player reporting profile being for a different employee-player previously selected by the employee-player user and having one or more employee-player reporting parameters including at least an assignment of the employee-player to one or more teams in a league. The method also includes receiving from the content server employee-player data associated with at least one of the employee-player reporting parameters of a particular one of the employee-players metric data identifying an activity or event having objective metric data associated with the particular employee-player and the team and league to which the employee-player is assigned.

Further the method includes transmitting at least a portion of the received employee-player metric data to the URM with which the employee-player profile is associated. The method also includes processes performed in the user resource manager (URM) resident on a computing device of each employee-player user having a display and a employee-player interface and being composed of a plurality of resource modules providing a graphical interface in the form of URM pages displayed on the employee-player user computing device display. The computing device has a communications interface that provides communications over a communications network to a communication device of each employee-player selected by the employee-player user of the URM. The URM includes the plurality of employee-player profiles with each employee-player profile being for one of the employee-players defined by the employee-player user and having one or more team parameters and one or more league parameters, with each league having one or more teams, and also has one or more employee-player parameters that includes one or more employee-player reporting parameters and one or more employee-player reward triggers. This include providing a plurality of league page displays as a part of the displayed URM pages, providing a plurality of team page displays as a part of the displayed URM pages, wherein the team page is a team to which the employee-player is a team member and providing a plurality of employee-player profile page displays as a part of the displayed URM pages.

This method also includes transmitting to the remote device at least a portion of the employee-player profile for each employee-player as the employee-player reporting profile including the one or more employee-player reporting parameters, receiving the instant employee-player data from the remote device and updating the employee-player profile with the instant employee-player data. The method also includes comparing the received instant employee-player data with a employee-player reward trigger defined in the employee-player profile, detecting in near real time as a result of the comparing an occurrence of an reward event, and generating an alert action to a component of the computing device of the employee-player user providing an indication on the computing device that the reward event was detected as a result of the detecting.

As described herein, in most embodiments, the PFL system and method does not require any data input by players as such is all automatic from the employee player perspective, so there is no duplication of work. PFL players participate on a team or teams in two or more leagues, but each player employee just continues to do their normal job processes and duties. The PFL system and method runs in the background to reflect each player's score based on league parameters. The PFL data is populated through file uploads or API/system integration. In some embodiments, the PFL enables each player to see all player employees who are participating on their teams, regardless of role or position in the organization and to see who is participating in the league, regardless of role or position.

### Definitions

Company or PFL Entity—A company or PFL entity as described herein can be any company or group of companies that form one or more PFL leagues based on a common set of agreed to objectives. This can be a single company, or a company and its suppliers, or a group of companies that are operating together for a common objective with measurable metrics and parameters. In such instances, each company can have a separate team with their employees on their team or the teams can be made up of employees have similar or supportive role, thereby engaging the employees towards the common objectives regardless of the company or their position or function in their employer company. In other embodiments, a “company” forming a league could also include a group of competing companies that compete in a particular market. As used herein, the term company is intended to include this expanded definition.

PFL league—A PFL league can be of varying types. By way of one embodiment, PFL leagues can be of three types: total points, head-to-head, and playoff. A PFL league can use different leagues for competition that may not be equal. Further, in some embodiments, the system and method can include divisions inside the league (AL/NL) to enables the client entity to break teams into equally competitive divisions inside a single league that can enable them to be all in the same league, but sales employees would compete against sales employees and non sales employees would compete against non sales employees, by way of example. Information with regard to a league, such as points, start and end dates or other criteria such as maximum points, winners, number and identification of teams in a league, league rules and point and reward objectives and rules, MVP criteria, league all star criteria top performing or “Crusher” parameters, establishing communications enablement as well as security, league visibility (access control such as when more than one league is active or may be considered to be only to a closed employee player group) and sharing of data within a league. Each of these can be established based on templates or received via a user interface for populating and receiving such league setting criteria. User interfaces are also provided for listing the established settings for each of numerous leagues that may be operational, such as for different operations or operational objectives within a single company.

PFL league season—A PFL season is an instance or determined time period or objective period within a league. In some embodiments, the PFL system is configured through algorithms established by various company based input criteria to automatically create a first season after a league is created. The system is configured so that each league can be restarted after previous season was finished. Restarting the league can create a new season for that league and can copy league settings\teams\players to the next season.

PFL team—A PFL team is inside PFL league season and is made up of PFL employee players. Each team is unique for the PFL league and is tied to a particular league at any instance. A PFL team can consists of the any amount of employee players and such players can be from any organization or discipline and not necessarily tied to a particular organizational entity. Each PFL team can have one or more captains as may be established by league parameters or team selection. The setting of team parameters can be enabled by manual user interfaces such as presented screens, or via API or a third party system. In some embodiments, a team can be established within a company to encourage employees in common, but often different, organizations, to work together towards the goals or objectives of the company, rather than merely within their own organizational structure.

PFL team captain—A PFL team captain is a player inside PFL team that can update team name and logo with permission. A captain can also have been given permission to see team players scoring pages and opposite players scoring pages for management of the team.

PFL team player—A PFL team player is a unique employee “player” inside a company entity or division or organization that is assigned to a particular PFL team.

PFL points—PFL points are generated by the PFL system and method based on receipt of predetermined parameters and event data as is predetermined to be received from external sources such as sales databases, and operational systems.

PFL Admin—A PFL program administrator utilizes an administrative interface for establishing PFL company league, team and player settings and administering and managing the company's use of the system by their employees. This can include, but is not limited to, settings page, adjusting points, and other features and options as described herein.

Matchup—A Matchup is a PFL competition between two teams in head-to-head or playoff league. Matchups can between two teams for any period of time such as one month at a time, or over any time period such as days, weeks, months or a calendar or fiscal period of time.

Profile—Each PFL player has a profile containing player specific data.

Supervisor—User that has Reportees

Reportee—User that has Supervisor

### PFL System and Method Introduction and Overview

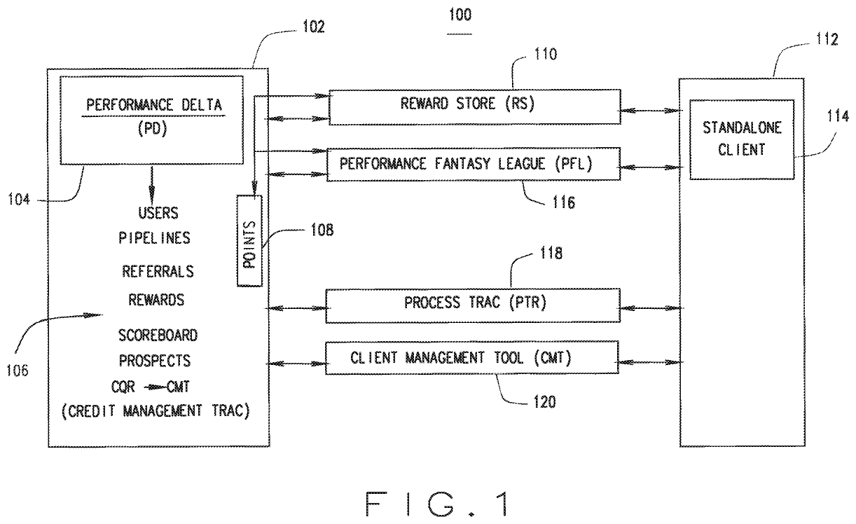

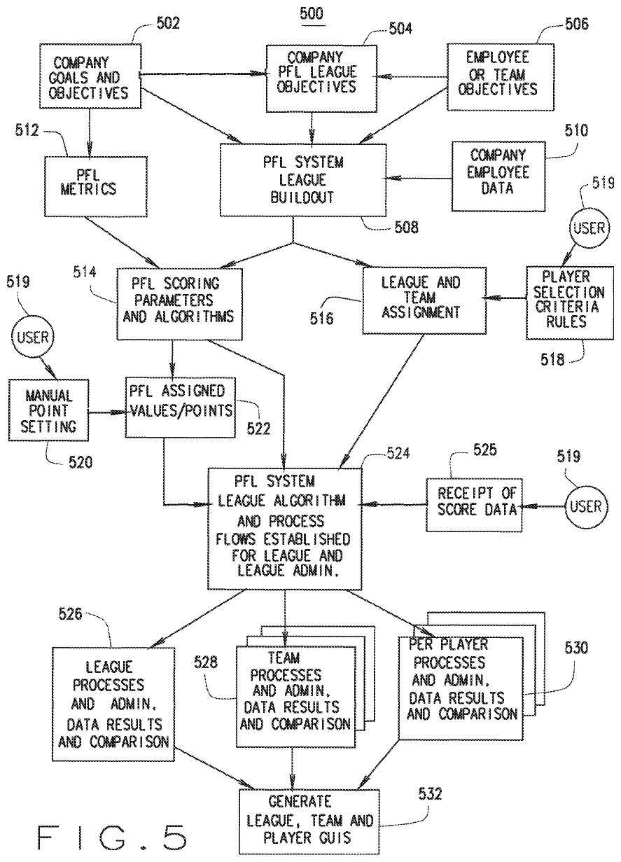

A PFL system and method are an operational system that has new functionality but that can be interfaced with or integrated with various company embedded operational systems for receipt or extraction of company and employee data. One example of such an embodiment is shown in FIG. 1 as a block diagram flow chart. As shown PFL system 100 includes a PFL host or server 102 system with a PFL system 104 installed and operational thereon. The PFL system 104 on the server 102 includes select stored or obtained data (via interfaces to third party systems 112), PFL data 106 that is a unique selection of receiving and system generated data based on the algorithms and methods described herein. One example of such is the PFL points 108. As noted in this exemplary flow, a rewards store 110 interfaces with the PFL 104 and with remote system or server 112 and in particular a standalone or third party client 114. The rewards store 110 provides for identification of rewards based on points, thresholds for rewards based on points 108 and the rewards store 110, the PFL 116, or the PFL 104 compares the player, team and league points and the rewards store 110 thresholds for allocating and operating of the allocation of rewards. Also as shown in FIG. 1, the system 102 interfaces with remote servers 112 for receiving either as a push or a pull server, external system data and events via a process track 118 interface and functionality. Similarly, a client management tool 120 provides a similar interface which can include, but is not limited to an API 154 as illustrated in FIG. 4.

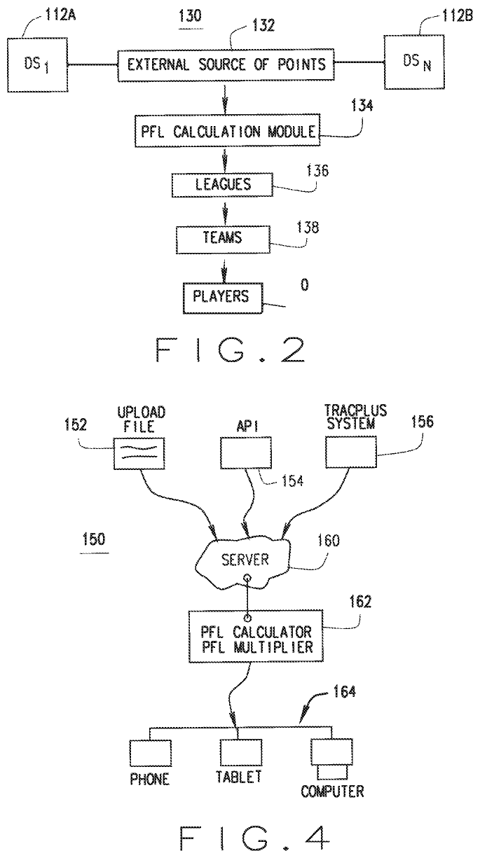

One exemplary hierarchical flow chart of the PFL 100 system and method is shown in FIG. 2. In this example, two external data sources DS1 112A and DS2 112B provide the external source of point in 132, which can be from a company sales or activity database. Once the source of points data is received in process 132, the PFL system utilizes a PFL calculation module which stores or accesses the thresholds, multipliers, and other PFL parameters for the PFL leagues, teams and players. The PFL module 134 provides or allocates the determined points to the leagues 136, teams 138 and players 140.

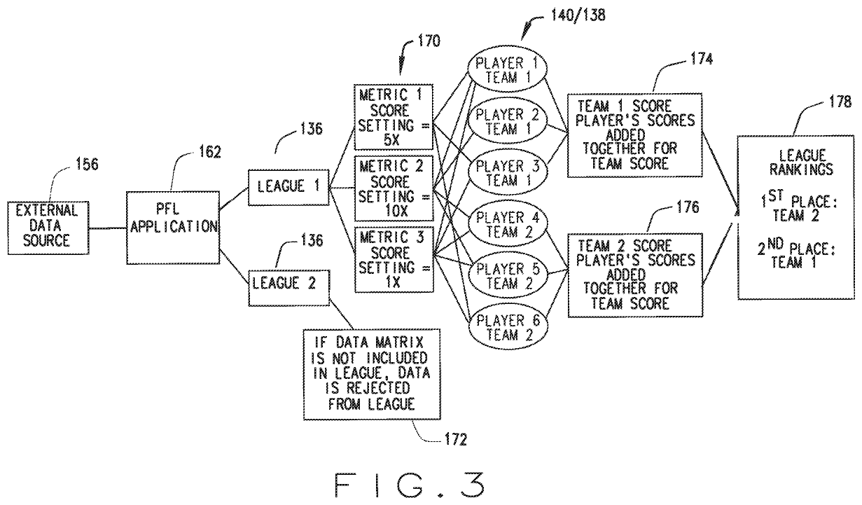

FIG. 3 is a relational flow chart 130 of a PFL system and method according to one exemplary embodiment of PFL 100. As shown starting from the left, external data source 156 provides external data either as a push or pull and possible over a PFL system API 154, or from an API for the particular remote system 156. The PFL application 162 determines the applicable league, either league 1 or league 2 (136) based on identification of the player or teams related to the league which is applicable to the received external data 156. As shown, the system can reject in process 172 any data that is not applicable to a particular league. By way of example, the league 1 data is utilized by the system is processed in metrics 170 for allocating the received data for league 1 into various PFL metrics 170 and applying a multiplier as may be predetermined by the system 100 or by a user input. Once the PFL metrics 170 have determined the scoring and points in the metric processes 170, the determined points are provided the profile or statistics of each player 140 in each team 138, recognizing that any player 140 may be a member of more than one team 138, but each team is in a different league, i.e., each player 140 can only be on one team in each league, but multiple leagues. After the player data is allocated, the team scores are accumulated for team 1 in 174 and team 2 in 176. From this, the league ranking process 178 prepares the summed and compared team ranking within the particular league, in this case league 1.

As noted above, an addressed in more detail below with regard to FIGS. 21, 22, and 23, FIG. 4 illustrates a system 150, having a PFL system 100 and method has a server 160 that hosts the PFL system 102 that includes, by way of this example, PFL logic 162 that includes PFL calculator and PFL multiplier. These logically interface via various data interfaces, such as a hosted GUI, to various data user devices 164. The PFL hosting server also interfaces with upload files 152, its own or third party application programming interfaces 154, or third party systems 156 for receiving or polling of data that is related to a particular customer implementation of the PFL 100. These can vary as described herein based on the parameters for which the PFL 100 system is being used and the leagues of company employees upon establishment thereon.

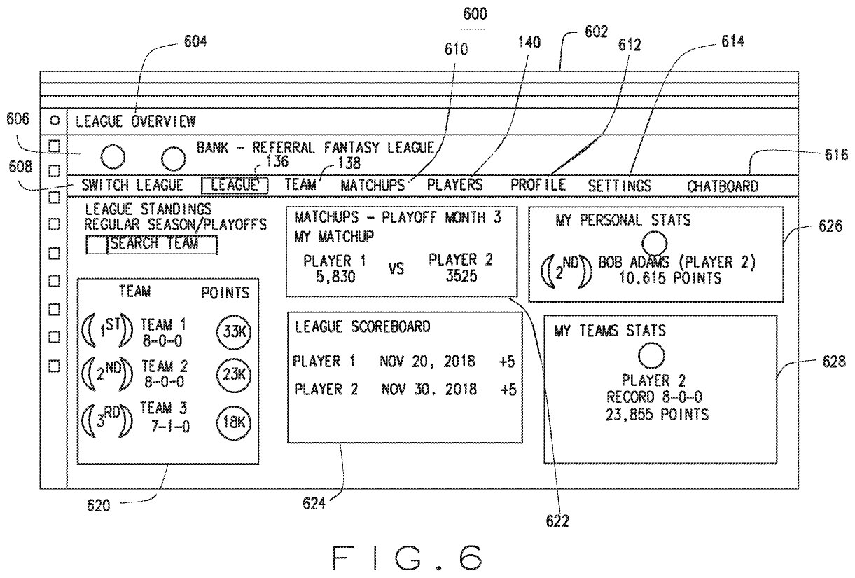

Another exemplary embodiment of the PFL process 500 is shown in FIG. 5. In this example, when a company initiates a new league 136, the system in input or configured based on using company goals and objectives 502, company PFL league objectives (such as short term sales quotas or similar league objectives) and employee and team objectives data each player 140 on a team 138 can be provided or identified or determined by the PFL system based on the company and PFL league objectives. The PFL system 100 builds the league in process 508. The PFL system 100 then obtains the company employee data in 510 for each employee player 140 within the league. In process 512, PFL metrics are determined based on the company goals, but in other embodiments these can be determined by other means such as for the league objectives in 504.

The process 500 continues wherein the PFL scoring parameters and algorithms are determined by the system or by user input in process 514. Further each player 140 is assigned a team 138 within a league 136 in process 516. This can be based on predetermined player selection criteria or rules in process 518 or by user 519 selection or determination of such criteria or rules. The PFL scoring points and algorithms are provided to process 522 for PFL assignment of values and points, or possibly metrics and multipliers. Further, user 519 can input via manual input process 520 the manual setting of points.

Next, the points, values and player team and league assignments are provided to the core PFL system 100 in process 524 for tracking, comparison of received data, application to the points and values, by way of example. The process 524 also received real time or near real time, or hourly or daily or monthly, by way of examples, of score data in process 525, that can be from a remote data source 112 or input by a use 519. The PFL system 100 processes the PFL algorithms and process data, such as the process of FIG. 3, by way of example, and allocates league processes, administration and comparisons in process 526, team processes, administration and comparisons in process 528 and per player processes, administration and comparisons in process 530. Each of these are provided to a system interface in process 532 which generates the league, team and player data via appropriate league, team and player graphical user interfaces (GUIs). Examples of the some of these graphical user interface data presentations are provided in FIGS. 6-20. These will be addressed in more detail below.

For a particular league, the scoring can be configured so that the PFL 100 system and method performs one or more of the following in various embodiments:
a. Only counts points from referrals Submitted on\after sets the date starting from submitted referrals can be counted for point calculation
b. Only count points from referrals Matched on\after sets the date starting from matched referrals can be counted for point calculation
c. The Last day that the PFL Admin can add points for a month defines how many days after the month end admin can add points to this matchup, after this deadline is passed matchup can be finalized.
d. Only count points from referrals between team members: Yes\No: If yes only referrals submitted between team members will be counted
e. Maximum points per account: limits maximum points that can be received per referral.
f. Exclude referrals if sender and recipient is the same person Yes\No: If yes, wont count points referrals submitted and received by the same user.
g. Points per submitted: Product\Category, can either count submitted referrals by product or category.

The result of this point setting is that after player data is loaded to the PFL system.

As described herein, the PFL system 100 is flexible and tracks anything that is a particular company or league creator may find as important to an employer user entity or other organization. During the setup process for the user entity, the initial settings and configuration provide for determining the criteria for the user entity to achieve. After the objective is determined, the system is loaded either manually or through external feeds that loads the predetermined metrics that are directed to or associated with the one or more user entity objective or objectives. It should be noted that for each company or organization for which one or more PFL leagues is created and operated, the PFL system 100 can be configured so that any metric can be created or used by the PFL system 100. Further, a league creator for that company entity can manually assign any value to any metric so that a player's performance is a direct reflection and influenced by the predetermined metric and its assigned value, weighting or multiplier.

The employees then complete specific activities to earn points for their team. If the client is using a performance metrics tracking system, such as that provided PerformanceDelta™ (TracPlus™ system), the metrics data can be moved over automatically and loaded into PFL. If the client is using other systems, they can load activity using an excel file or can be automated or manual upload data or files.

In this and other embodiments, the PFL system can perform similar or processes including, but not limited to: determining a league objective; creating metrics and goals that can influence the league objective; select or pick employees players that can achieve the metrics and goals; drafting employees players into teams in the league to compete with one another; determining prizes or rewards that winning teams in the league can receive; developing employees player best practices; establishing employees activities linked to metrics to score points for their team; combining employee's points with teammates to determine team score; ranking teams by total points or their win/loss record; and determining for the winning teams any rewards and prizes.

Further, the PFL can be configured to enable players and/or teams in a league to compete directly against other players or teams for a specific period of time. In such embodiments, teams are then ranked based on their win/loss record rather than their overall performance. This can be within the league or as a subcomponent specialty sub-league or challenge.

The PFL can include or be based on various criteria, such as that every league or campaign can be linked to an objective of a company. The PFL system and method as described herein provides for the client entity rally the employee players to achieve the company organization's goals. Further as the employees are the “players”, they can score points by accomplishing things that are important to the organization. In one financial company example, this can be loan growth, referrals, community service. For other companies, such can be whatever is needed or desired to achieve the organization's objectives. Also, employees can play in multiple leagues at the same time. For example, in a financial user entity organization, a loan officer can be in one league that is a bank-wide league that tracks referrals for points and also in a lender league that is tracking loan growth for scoring.

When first setting us a PFL for a new company or league, considerations are provided to the PFL system that can include high level considerations, such as objective(s), what are they trying to accomplish, determine metric(s) such as what should the player employees need to do to accomplish towards the objective, and identify measurable metrics that can be included in the league.

When allocating players to a team, it can be similar to a draft. Consideration for selection criteria can include identification of what employees can contribute to the objective that you are trying to reach, identification of the best way to distribute employees to inspire the most competition, and how does each player need to do to accomplish towards the objective using measurable metrics that help define the league scoring. Further, rather than through the PFL system process, a user entity 519 can create teams of employees that are identified that can contribute to the objective that the client entity is trying to reach, as shown in FIG. 5 process 518. This can consider the best way to distribute employees to inspire the most competition.

The PFL 100 or a league 136 can be developed by a client user to include consideration of how long the company wants to operate a league/campaign. This can also include the teams to play against one another in head to head matchups (best record wins the league) or should the team with the most points wins the league. This can also include what metrics or objectives that the employees can accomplish through the scoring of points for their team.

Generally, the requirements for a league can include, but are not limited to the following exemplary league requirements. Employee/Player ID, date, reason for points, number of points earned, customer name, and description of activity. Once the league file is created, the file is run through the PFL system 100, and the players' points are added to their account and their scores are combined with the scores of their teammates.

When accessing a PFL GUI interface presentation, an employee player can see all of the leagues they are participating in. Supervisors can also see their employee players and how they are performing. The system can also enable a person using a GUI to select a league from the list for the company entity and each league can have a specific home page or dashboard.

Each PFL league can be configured with league specific rules, scoring opportunities, players, and points. For example, one league can captures referrals and another league tracks community service hours. The league rankings for each team can be determined by numerous manners. Two examples include by total points, where each team race to the most points, and the teams are ranked from high to low based on the number of points their employees have scored. Another example is by a matchup. A matchup is where teams in a league play against one another in head to head competition with the league rankings being based on the team's win/loss record.

Each league can be customized upon creations through a set of PFL configures PFL league settings. These can include league name, a league logo such as a picture that is uploaded as a graphic for each league, the number of teams participating in the league, and league or season start and end dates. The league type can be established by setting a total number of league points, wherein teams are ranked by the number of points earned with the team with the most points winning the league. Another is where it is head to head and teams play each other every week or month and the teams in the league are ranked by their win/loss record, with the best record winning the league. The league can also be established with playoffs. A league with “Playoffs” has a regular season and playoff series, with either being either total points or head to head. In this case, the playoff start and end dates can be defined. For example, if the playoffs are “head to head”, the length of the playoffs can be determined by the PFL system based on the number of teams included in the playoffs or establishing playoff brackets. The PFL can also establish playoffs where certain teams are eliminated after they lose to other teams in head to heads matchups.

The league settings can be configured automatically or by user input as described above. The PFL 100 can enable a user to set league name, set league logo, if none the PFL 100 can draw first letter of league name, set number of teams (mandatory), select league type (if playoff asks regular season and playoff start\end dates and number of teams in playoffs), and use matched referrals previous month in current matchup. By way of example, if matchup is from 1/1/2018 to 2/1/2018, this setting would allow to use referrals matched before 1/1/2018. In such examples, this can include use of submitted referrals previous month in current matchup: If matchup is from 1/1/2018 to 2/1/2018 this setting would allow using referrals submitted before 1/1/2018. The user can also set the rules to define league and team MVP, turn on a message board or email capability for entire league or a specific team. Further, the user can predetermine the visibility for a league, such as enabling who can see each particular league results and data. In some embodiments, the PFL league settings can be configured so that the in a scoring setting, a direct points can be enabled or disabled.

The PFL 100 can be configured to receive and store in its system memory one or more predefined direct rewards that can be available to the PFL 100 system and during operation based on selection criteria of an administrator or by a user within a league having authority for assignment and utilization. These can include various predefined and stored criteria such as a PFL name of each direct reward, a PFL direct reward code, a PFL description of the direct reward, an amount of PFL 100 system direct rewards available for a league, an indicator that direct reward is locked or unlocked for access such as for a particular league or status of the league. Further, for each reward, the PFL 100 can include storing of a set of PFL league or system point setting values or multipliers that can be established for a league and can also include a date range for selection and applicability, and can include a variation of point values or multipliers that are based on other criteria such as date, by way of example. Multipliers are used by the PFL system to increase the points earned for activity for a certain period of time. This feature can help employees focus on the activities that the company thinks is most important. If the client need a certain activity accomplished earlier in the league, the PFL system can be configured to make the activity worth more in the beginning of the league than in the end.

These can be received from one of the defined data feeds or manually or automatically from one or more of the PFL 100 data collection feeds or interfaces as described herein. A PFL user interface such as a GUI or screen presentation can be provided for showing the stored data as well as for user review, administration and management of the direct reward data as described herein.

The PFL 100 system can be configured for a time period to be established for a particular predetermined reward to be counted by selecting Start Date and End Date. This can include the enabled capability for the system process to go to the direct rewards list from the configuration page and input fields for each one. The values set in inputs can include multipliers. For example, if PFL Admin set “5” as multiplier for DRP Tester 1 reward and then can upload a file with the correct date that matches period set, all points received by a user can be either Points from direct reward file X Multiplier set in league settings or Points per referral submitted in referral category (through integration with an external metric tracking system such as provided by PerformanceDelta™) can include points that are added when user submits referral in external metric tracking system.

The league settings enables to set exact number of points that player can receive in league for submitting one referral per referral category. This can include one referral submitted into referral category, points set for referral category in league settings, points earned by player for league. This can also include Points per match per referral product (through integration with an external metric tracking system such as provided by PerformanceDelta™), that can add points when referral product becomes matched in external metric tracking system. This can be configured to triggers a predetermined event that synchronizes points with PFL.

In some embodiments, under league settings, the PFL Admin can set how many points per match player can receive in this league. In some examples, one referral product matched equal X points set for referral product in league settings=points earned by player for league. This can also include Referral rewards points (through integration with an external rewards entity such as PerformanceDelta™, by way of example.) This can also be configured to enable the PFL Admin to set multipliers for points received from an external rewards system such as PerformanceDelta's Distributed Rewards Report.

PFL league settings can be set by the PFL Admin to include a multiplier for points player can receive in this league for specific reward name. This can include setting the Points player can receive and the Points received for specific reward X Multiplier set in settings for this reward. This can also include Manual rewards (through integration with a third party Rewards System such as that provided by PerformanceDelta™). This can enable the PFL Admin to set multipliers for points received from PerformanceDelta's manual point rewards. By way of example, this can include Points player can receive and the Points received for specific manual reward X Multiplier set in settings for this reward.

As noted points can also be manually uploaded. In some embodiments, the system can enable the PFL Admin to use or upload manual points upload to adjust points for predetermined criteria or reasons. For this, a PFL Admin can select the league and the manual points upload in presented menu. After this, the user can be asked to upload file with points per employee with reasons. In this example, it is likely that most of uploads for dates that effect active matchups can require recalculation that can change its winners and greatly change results. Further, the PFL Admin can also setup direct awards as described herein for the PFL league or leagues of the company entity. The PFL legal admin can create any metric and assign a point value to that metric. As the PFL received uploaded or transferred results for that particular metric, the metric drives the calculation of the points directly or through a multiplier, or possibly a predetermined or defined table listing, and then assigns the determined points for that performance metric to the player employee.

The PFL 100 for a league can enable a player to also earn predetermined badges by completing certain tasks or scoring a certain amount of points.

In some embodiments, the PFL leagues can be configured to that the results that impact a team or the company can be generated as a display or dashboard to the players providing the player with a direct reflection on how their individual and team performance has impacted the organization or company.

The PFL 100 can include league and team MVP. These can be established by various criteria including, by way of example, most points on winning team, most points in the league, or winning team's MVP based on team votes. The PFL system can be configured to turn on and off the Team MVP feature.

The PFL 100 can establish or support settings for teams in a league that can include, by way of example, team captains, the number of team captains per team, and additional permissions for administrator and team captain to change team name\logo.

The league visibility capability provides the PFL leagues and teams to have visibility permissions. By way of examples, this can include visibility only by PFL administers, and hide the league from all players or only allow certain captains or players or users to add data or input or see team or league data. In some embodiments, every player in the league can see other players' point amounts but the point totals themselves do not show any confidential information. There is one page in the league that can contain a customer's name. The PFL can restrict access to this page for other players in the league. Visibility settings are shown below. The PFL Admin can setup league to track employee performance in the background. The PFL Admin can hide the league from the employees so they cannot see the results.

A communications or messenger capability can be provided by the PFL 100 to enable users to communicate on league or team chat or via embedded or external email communications. Another example is where the league or the team has established a top performer or “crusher” top performer in a league are identified and the other players on a team or in the league, as established by the PFL Admin, can message or post comments to the top performers for congratulations, or otherwise. This can also include a team chat or message board that allows team members to send messages to one another or allows league members to sends messages to one another.

Further, the PFL chatboards can be configure to enable players in a league to challenge one another in a playful and competitive way and also to share their best practices and tips with other players on their team or otherwise without being seen by other players in the league.

A PFL playbook can be implemented that can provide a Playbook feature where the players input their commitment for their team. This can include, by way of example, Title which is a statement of their commitment; Specifics of what the employee intends to accomplish; players estimates the number of points they can score; system tracking of projected versus actual results as the league continues wherein all team members see everyone's commitment. The playbook feature can also provide a way to post best practices/share ideas between teammates.

A PFL meeting planner can also be provided wherein the PFL 100 enables a PFL Meeting Planner for employees on a team to create meetings and send invites to other teammates. In such, cases, the agenda can be uploaded, minutes can be tracked, attendance can be tracked, and meetings can include a chat board and/or email communications enablement, as well as a Hall of Fame where the PFL Admin can add photos and information about the best PFL players.

In some embodiments, the PFL 100 can enable players, captains or the administrator to upload videos to certain leagues or all of them. This can include generating a “sports center” interviews with some of the players and share them with the league. In some embodiments, the PFL 100 system and method can be configured to enable activity tracking for criteria or metrics that earn points or badges or those that do not but that can still provide value in the PFL or user tracking system and method. Currently, anything that is being tracked in the league earns points. Activity tracking would allow different activities to appears in the league and not earn points.

### Examples of PFL Points and Scoring:

As addressed above, the PFL utilizes points. This can include only counting points for predetermined activities such as, by way of example, from referrals submitted after where in referrals sent after the date chosen can be used in the league to calculate scores. Or in some embodiments, the PFL system can be configured so that only count points from referrals matched after that are referrals matched after the date chosen can be used in the league to calculate scores. In one example, this can be the maximum number of points per account. In such embodiments, this can keep one team from running away with the league based on one large account.

The PFL system can be configured to exclude referrals if sender and recipient is the same person. For instance where some Client Users may allow their employees to refer to themselves for tracking purposes. The PFL system can be used to turn this on or off to ensure that the employee does not get credit for these referrals in the league.

One example of a third party data feed and interactive system for the PFL is ReferralTrac™. As used herein, this system is a system that provides the PFL with relevant external data such as Submitted Referrals, Matched Referrals, and Referral Reward Points. This can include inputting customers, and documenting call notes, looking as prospects such as sales calls, setting a meeting with prospect, and referrals to other lines of business. As to performance, this can include, for a bank company, loan growth goals, teller over/short S, documentation exceptions. In other examples, research can help wherein there is an ISQ department score, a reverse evaluation score, tracking of community service hours and the sending of thank you notes or messages. For each, the PFL system can include in the file format, the employee ID, date, reason for points, and result.

The PFL point settings provide the capability for the PFL client entity to set point amounts for various metrics. Point amounts can be different for different leagues. Point amounts can also be different for various time periods within the same league. For example, a submitted referral can be worth 5 points in January and 2 points in February. This can also include the points be designated or selected or determined by the system that can subsequently be assigned or allocated to a given players based on predetermined parameters and criteria such as a category. Different point amounts can be assigned for each category or product. This can be provided or determined for various categories, such as, by way of examples, an selected amount of points for categories in a banking or financial institution company such as: issuance of a business loan, issuance of bank card, CSR deposits, investment service provided to a customer, opening a safe deposit box, providing a seminar, handing a loan collection, handing a business deposit, obtaining an application for a home or home equity loan. Of course, each category can vary based on the company determined metrics and industry practice, as well as based on goals and objectives that are provided by various company systems and manually input. Where a league is set up based on points scoring by category, a player can only get points for a referral category, regardless of how many products are selected in the category. Similarly, if by product, each player can get points for each referral product selected on the referral form. For match play, points per match can provide players with points for matched referrals such as in a ReferralTrac™ system. Different point amounts can be assigned for each product, and can be determined or generated similar to the points as described above as to Categories and Products. Similarly, these can be automatically determined by the PFL system based on input company objectives and parameters, or can be received via system user input.

Similar to points per match or category or product, a referral reward point setting can be provided via manual or a remote system feed such as by ReferralTrac™ rewards, as one example. Referral reward points can include multipliers of the actual reward as received from an external system and different multipliers can be assigned for each reward. These can be similar to the exemplary listing as disclosed above for the banking company as to Category/Products.

Additionally a manual entry by user 519 is provided. As noted above, each of the reward points, their setting and quantification for category, product, match or referral, can not only be provided by an interconnected system, but can be received by the system via a manual user interface. Points can be provided by the administrator to a team or a player based on criteria that is not defined, or as a bonus for a non-PFL predefined performance milestone or achievement, such as, but not limited to security awards, community service, new employee referral, training, special events, etc. A user interface can be presented for prompting a user to establish manual point uploads or specifications thereof. This can also be performed by importing a predefined file via an application programming interface (API) established for such receipt, or from another third party system. A PFL manual reward system can provide the PFL 100 to generate points for ReferralTrac™ manual rewards. Points in this section are a multiplier of the actual reward that may be generated or received from a predefined interconnected system, such as ReferralTrac™. In other embodiments, the PFL 100 administrator 519 can give points for any desired metric. These points are not related to any rewards in ReferralTrac™. Multipliers can be used in this section so point amounts can be different in various leagues.

In other embodiments, a direct reward point setting, which is similar to PFL only points as addressed above where a client can give points for any desired metric, the direct reward points provision can differ from PFL only points as to the global metrics that can be used across all leagues for a company. The PFL administrator can upload one file to PFL 100 and data can populate any league that is using direct reward points in its league settings or definition.

The PFL system can be configured to receive direct data transfer from external metric tracking systems or client entity legacy systems. For example, in one embodiment, where the client entity uses ReferralTrac™ data as provided by the PerformanceDelta™ ReferralTrac™ system, such data can be transferred automatically to PFL. In other embodiments, upload files may be needed unless an interface is customized to receive such specific for the client entity. By way of example, a team upload can be a .csv file format with Column A: Employee ID; Column B: Team Name; Column C: Team Captain (input yes or no); PFL Only Points Upload—The admin can upload points to PFL for any reason or any metric.

Further points can be uploaded using a .csv file. Such as file format might include: Column A: Employee ID; Column B: Date; Column C: Reason; Column D: Number of Points; Column E: Customer Name; and Column F: Description

A team page can be generated that is similar to the league page. The players on the team are ranked high to low based on the number of points they have scored. Another feature on this page can be the message board. In some embodiments, there can be multiple message boards. For example, in one embodiment, there are two types of message boards. One for the league and one for the team. Only teammates can access the team message board and the PFL can typically share best practices and encourage one another. All players in the league can access the league message Board. The league message board is typically used for “smack talking” and challenging the other teams.

The team page can be configured to enable a user to click on the Player's points and the system can display their player's scoring detail.

The player scoring page can provide an audit trail for the points that the player is earning. This can enable the displaying the number of points earned and the reason for the points. Based on the client, the PFL can allow or block other players from seeing this page.

### Exemplary Embodiments—PFL Graphical User Interface (GUI) (PFL GUI)

PFL 100 is mobile friendly wherein employees can access the system, check their team score, check their own score, and do a little smack talking while the employee players are at it. The PFL 100 generates a new enabled system for companies which engages employees in a fun and competitive manner.

Whether on webpage on a computer or a mobile device or mobile application, a PFL home\welcome screen structure can include, by way of example, webpages such as lobby/dashboard, all leagues, matchups, my profile, and settings.

For example, a lobby or dashboard can be generated as a PFL GUI that is a home page of the PFL 100. For such, this can be customized for a league or company having multiple leagues. This enables any PFL user to navigate between menu and show welcome messages.

In one generated PFL GUI, a listing of all leagues in a company can be generated. This can include all league name, with actual unique league name, including league logo, a league type, such as by total points, head-to-head, or playoffs. This can also include a listing of total points earned by all players inside the league, the number of teams participating in league, the number of players in the league or on each team, the league season with league open date and league close date. Further, this can also display each league status, open available actions, and filters such as to search by league name, league status, show “My leagues” or “Reportees leagues” if user is Supervisor or PFL Administrator (PFL Admin). This can also show matchups for each player or for a team.

Another GUI presentation provides for each player the player's profile, which can include player name, text field defining college of the player, player position, favorite team, and a player graphic or icon.

In another GUI, the PFL system can display current and overall teams current user is participating in. For each team this can include league name, team name and points earned. The summary can show total score from all leagues, highest point total, league MVPs, and team MVPs. Also this can include a scoring section that shows how user receives points, a scoring date that shows month\year of scoring in Month\YYYY format, a reward date that shows MM\DD\YY of reward by which user received points, a customer name that shows a customer name from which a point was earned, a point or referral category, a product and a reason for the receiving the points. Further a custom description for the points as well as the actual number of points received by user for a particular customer. Other possible PFL filters and data displays can include by league, season, team, customer name, scoring date start-end, referral category, referral product, reason for points. In some embodiments, the status of one or more leagues can be displayed. These can include where a league is a draft, such that the league is saved but it may not start automatically when start date is reached, the league is not started, but the league is created and is waiting till start date is reached, the league is active, and the league is finished as the date is past the end date of the league.

As addressed above with regard to FIGS. 1-5, the PFL system provides various user interfaces for providing the player employees and the administrators with a unique PFL experience that displays all the relevant data to a player employee in a fun, entertaining and meaningful manner. By doing so, the employee player become more engaged and are interactive with the system and with the other player employees within the company organization, all focused toward the league objectives that support one or more company objectives.

By way of examples, FIGS. 6-20 provide various examples of player employee interface as PFL webpage or mobile device screen presentations of the PFL systems outputs as described above and herein.

Referring now to the specific user interface exemplary representations, FIG. 6 is an example of a webpage presentation by a PFL system 100 illustrating a PFL league overview dashboard for an entire established employee player and team league status information. As shown in the PFL league overview example webpage 600, a display 602 includes a webpage title banner 604 and a league title banner 606 providing an identification of the particular league being displayed. Below that is a user control or tab ribbon 608 that provides the user control or selection tabs within the league overview webpage 602. These include the selections of changing leagues, if another league to be viewed is desired, a league tab 136, a team tab 138, matchups 610, players 140, profile 612, settings 614 and a chatboard 616. Each of these are linked to separate displays, some of which will be described further by way of example. Some examples of these tabs will be described in FIGS. 6-11.

As shown in the league 136 tab dashboard being illustrated in FIG. 6, the left window display 620 displays the team standings within the league that includes their placement, the team, its record and the number of team points in the selected league. The top center window 622 displays the matchups or head to head matchups in the league with their current matchup shown, but allows a user to switch within this window to another. In window 624, the league scoreboard displays the new points that are being added that can encourage updates and competition to the viewing players. In window 626, the viewing player's statistics are shown as well as their placement and number of points. In window 628, the player's team stats are shown along with the team record and team points. This display can also provide a window showing an team MVP, league MVP, or other metric that may be suitable for a particular PFL league.

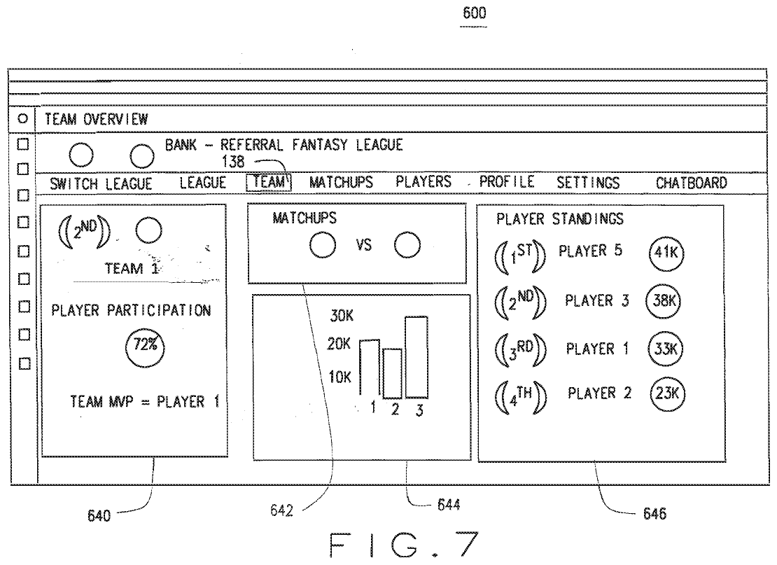

For the league page 600, FIG. 7 illustrates the team tab 138 for the same league as FIG. 6. In this example, the team tab can include window 640 that illustrates the team name (Team 1), the Team's current ranking in the league, and an amount of participation of the players on the particular team, the latter of which can help drive other players to more fully participate. This can also include the identity of the team MVP. In window 642, an identification or listing of any matchups between the illustrated team and another team is shown. Window 644 can provide team analytics such as the accumulate score for each of the team players, which is shown to be 3 players in this example. Of course any other team analytics that can provide a player on the team with insights into the team points and position can also be displayed. Window 646 lists the players on the team and ranks the players from high to low based on the total points scored by the player for the team.

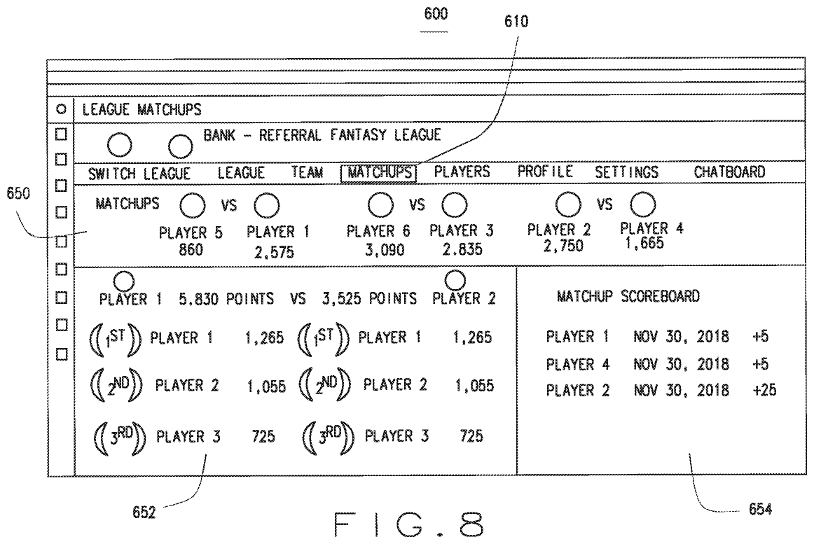

Also for the league page 600, FIG. 8 illustrates the matchups tab 610 for league matchups among various teams or players in the league and the current player performance data and matchups scoreboard. As shown in Window 650, this generated display provides teams playing against one another, or can also be players within those teams. The Team matchups are shown. A user can click on a displayed matchup between two teams, and window 652 provides a display of the player performance in the user selected matchup as well as their scoring position. Window 654 shows the latest points added to the selected matchup.

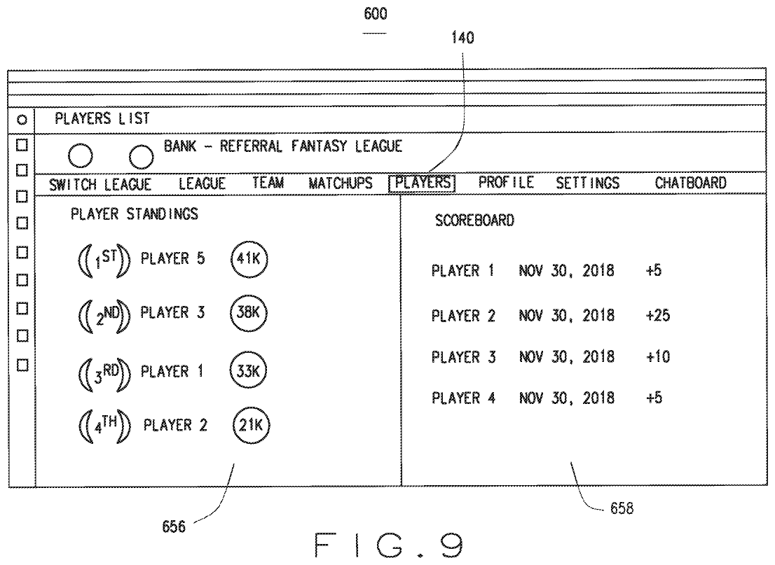

FIG. 9 similarly illustrates the players tab 140 to the league webpage 600. In this illustration of the players page, in window 656 all players in the league are ranked by the number of points. The window can enable a user to filter or select or scroll or search based on metrics. Window 658 provides the latest scoreboard that are being added to the system based on the latest PFL events and data received thereby.

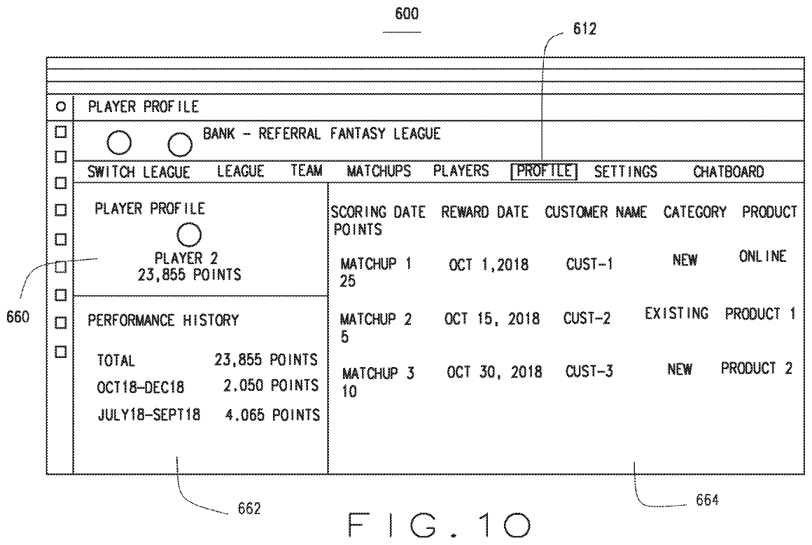

FIG. 10 is a screen shot of a webpage for a PFL system and method illustrating a webpage for player profile presentation for players in a PFL league along with a performance history for those players in the league according to one exemplary embodiment.

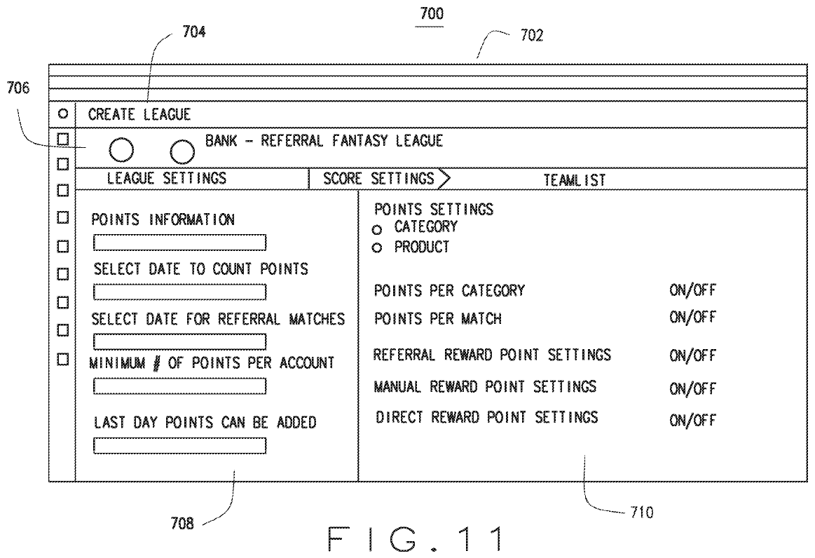

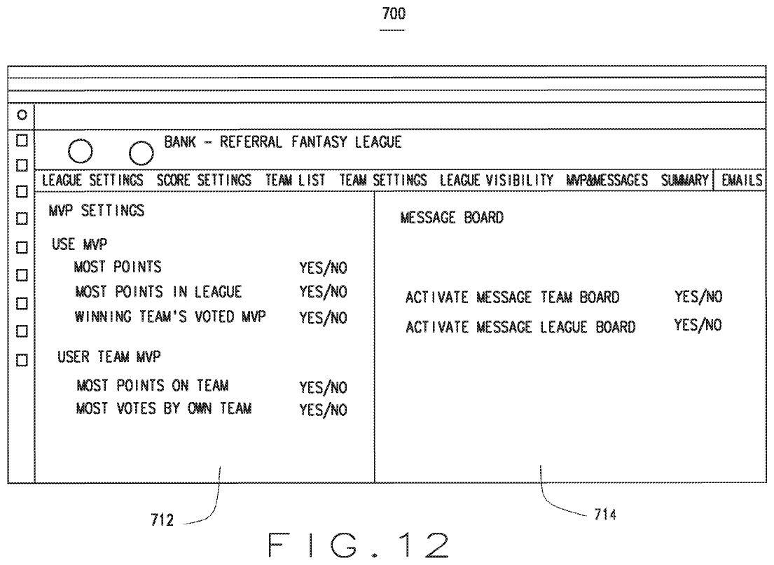

The player profile tab 612 of the league page 600 is shown in FIG. 11. As shown in FIG. 10, the player profile 612 can include a window 660 that displays a particular player so that such player can see their ranking in the league and any change in ranking. Additional player profile data can be linked within this window or by scrolling. Window 662 provides the player performance history. This can show the player different time periods within the league, such as points for each time period or in matchups. The user can click or scroll through this window based on a specific time period or filter data. Window 664 provides a scoring of all points that provides the player in their profile an audit trail or history of all the points that the player has earned and further detail as to date, customer or product, by way of example.

Of course, FIGS. 6-11 have illustrated a league summary page 600 with some examples of a particular league. As addressed above, before these can occur, a PFL administrator must set up a league and teams and players in the league. This is described in detail above, but FIG. 11 provides one example of a administrator screen shot for setting up the league scoring and point settings. As shown in this example, webpage 702 is for creating a league as shown in ribbon 704. The user has named the league in ribbon 706. Window 708 provides a presentation to the user for enabling the user to establish the points information for the league. As shown, this can include, but is not limited to, selection dates for counting points, referral matches, the minimum number of points per account, and the last day points can be added, either manually or received from an external data source. Window 710 illustrates point settings for the league such as for category and/or products, wherein the user can configure the point handling for the league being created. By way of illustrated example, this can include the ability to turn on and off point features and settings.

Referring now to FIG. 12, a screen shot of a PFL webpage 700 providing for enabling league MVP setting in setting up a league in Window 712 and also for setting up a league message board functionality in Window 714.

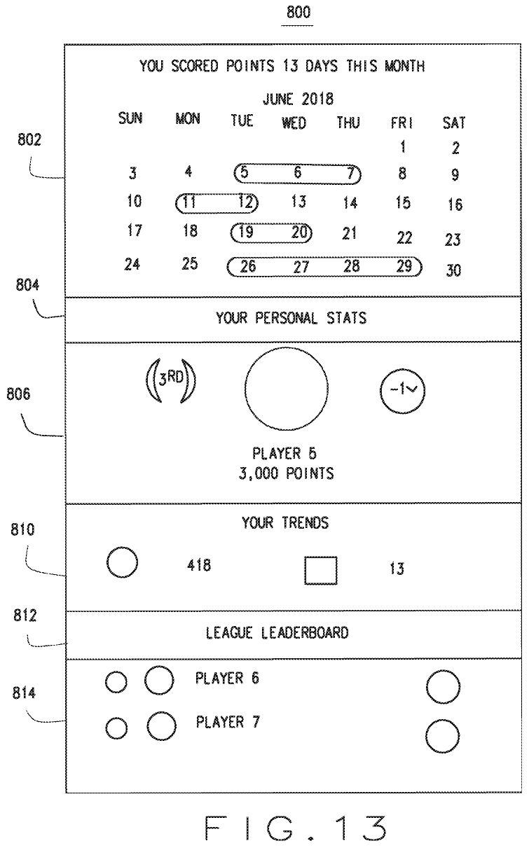

FIG. 13 is a mobile device a webpage/screenshot generated to provide the user interface with a sample of emails that illustrates an automated recap for player or team of such items as weekly or monthly performance statistics in a league. These can include, by way of example, player and team standings, the days that points were earned, metric and statistical trends, team and league leaderboards and company goals. In this example of FIG. 13, all generated content is related to an email update to the user as to these items. Of course other forms of update can also be provided, such as by auto-generation or text messages or chat board messages, by ways of example. For each, as in this email based example, this generated update s can be automatically generated and forwarded to each player to provide an interactive update to engage the player more fully in the league and performance therein. In some embodiments, as shown for this mobile screen display 800 for a player, a first player window 802 can generate a calendar and illustrate the days on the calendar when the player scored points in the league. Another display can show the personal player statistics in window 804 that can include window 806 that has the player league position or rank, the player points and the player badge. In window 810, the player's trends as to scoring can be shown. Window 812 shows the league leaderboard and window 814 shows the ranking of various league players that can be sorted by rank or other criteria. It should be noted that the PFL 100 can be configured to enable players, team captains, supervisors, and admins to create instant leaderboards based on all points or filtered metrics. Employees can easily be ranked by selected criteria.

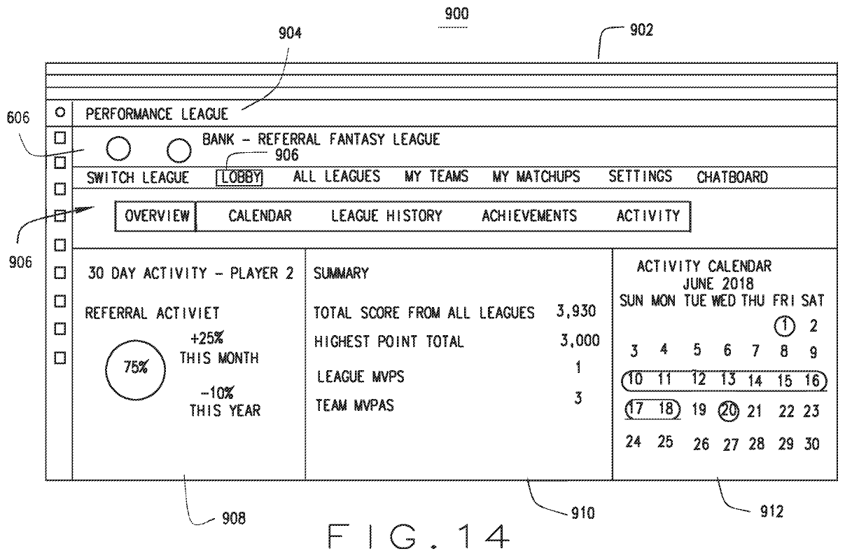

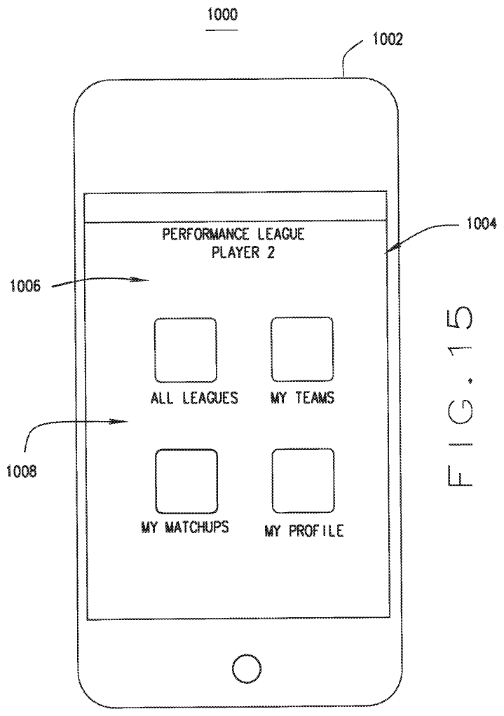

FIG. 14 is a screen shot of a player webpage 900 with display 902 for a PFL system and method illustrating of an overview of one PFL player's PFL activities and scoring in the PFL leagues and a PFL calendar for past PFL player events. As shown, this player dashboard 902 includes a lobby tab 906 for the league 904, along with other player tabs for easy access such a various teams, past matchups and leagues, similar to the league dashboard 600 of FIGS. 6-11, but from the player perspective. In this example, the player dashboard 902 provides an overview to the player for all player's leagues and teams in one place. This also shows the player's past achievements in Windows 910 and 908. Window 912 provides a calendar of events such as past matchups and also the scores and dates scored similar to the mobile display 800 of FIG. 13. This shows which days a player has scored points for the past time period. For each player, a league summary is provided, achievements such as awards and placement and rank is illustrated and activity for the player is shown, all in one webpage 902 thereby providing each player with a user friendly quick reference of their league and team participation.

FIG. 15 is an image of a mobile device graphical user interface for a PFL system and method illustrating a player's mobile home page. Mobile device 1002 has a display 1004 that presents graphically produced PFL data in a window 1006 that include user selectable icons 1008. In this example, as shown this is for the PFL for player 2, and offers the player the choice of going to all leagues, to my teams, to my matchups and to my profile. This can be a home page for a PFL mobile interface or PFL mobile application.

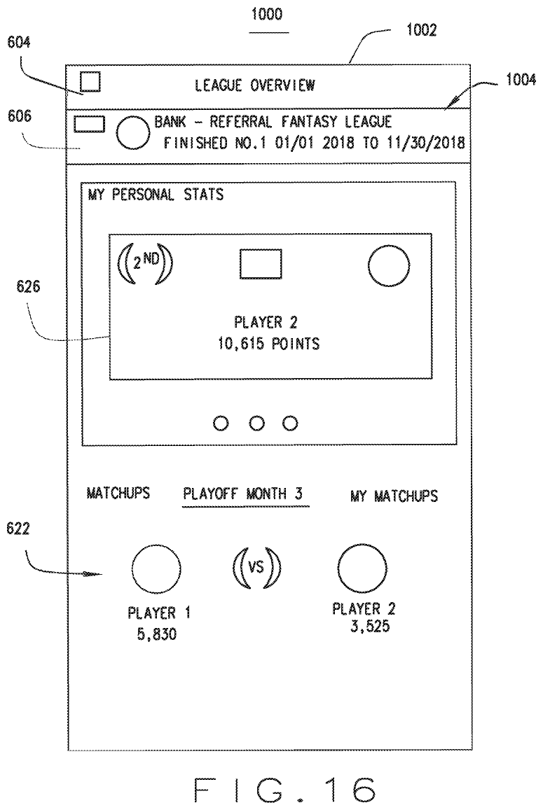

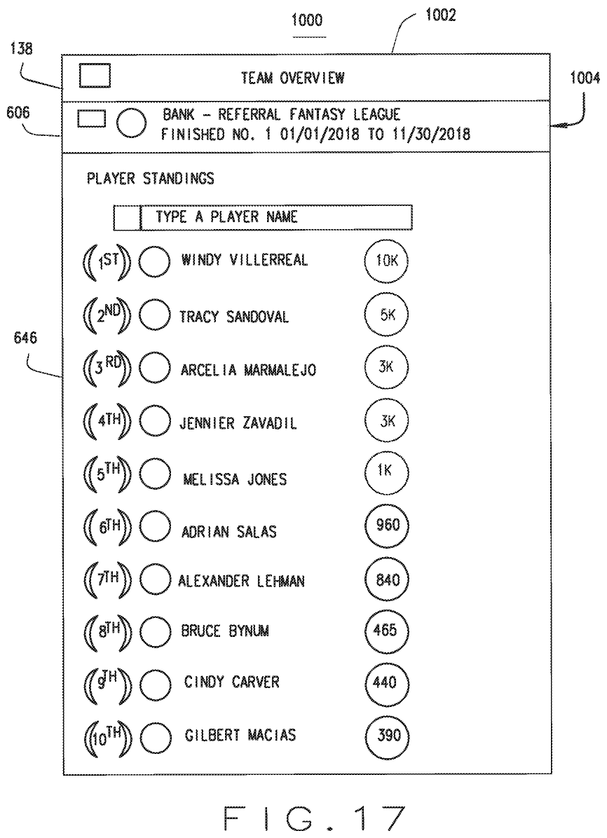

FIG. 16 is an image of a mobile device 1002 with a graphical user interface on display 1004. In this example, a league overview 604 is displayed. The league is identified in ribbon 606 with the player's personal statistics in window 626 and upcoming matchups for the player in window 622.

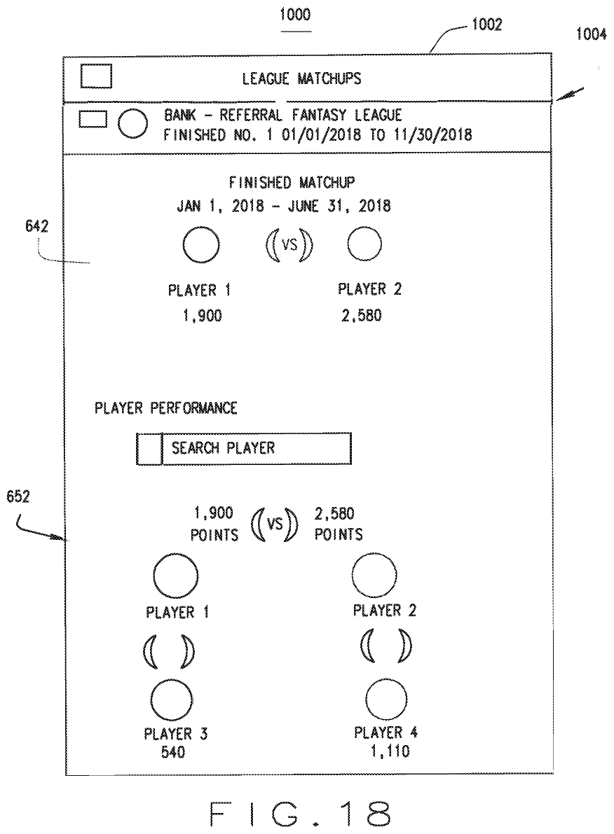

Similar to the league overview 604 of FIG. 16, FIG. 17 is an image of a mobile device graphical user interface for a PFL system illustrating the presentation of team page 138 for league ribbon 606 with a listing players by their standing in window 646. As shown for each player in this team, a PFL team includes an identification of the player and the team points that they have accumulated.

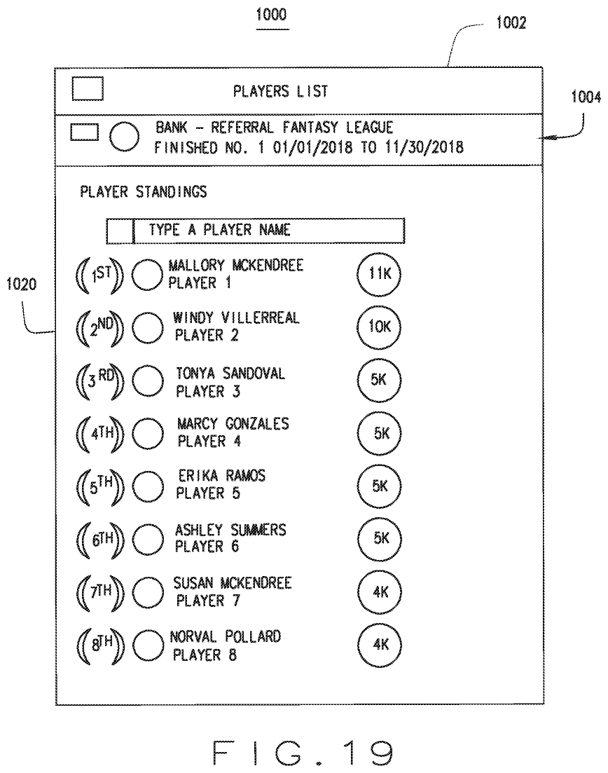

FIG. 18 is a mobile device 1004 with a graphical user interface display 1004 that includes in window 642 an identification of the finished matchup between players and in window 652 the player's performance. As can be seen, the player can select to review the status for another player in their league or team and any matchups that are planned or that have occurred.

FIG. 19 is a mobile device 1002 with a graphical user interface 1004 illustrating in window 1020 a listing of the players by their standing, along with the rank, name and points accumulated.

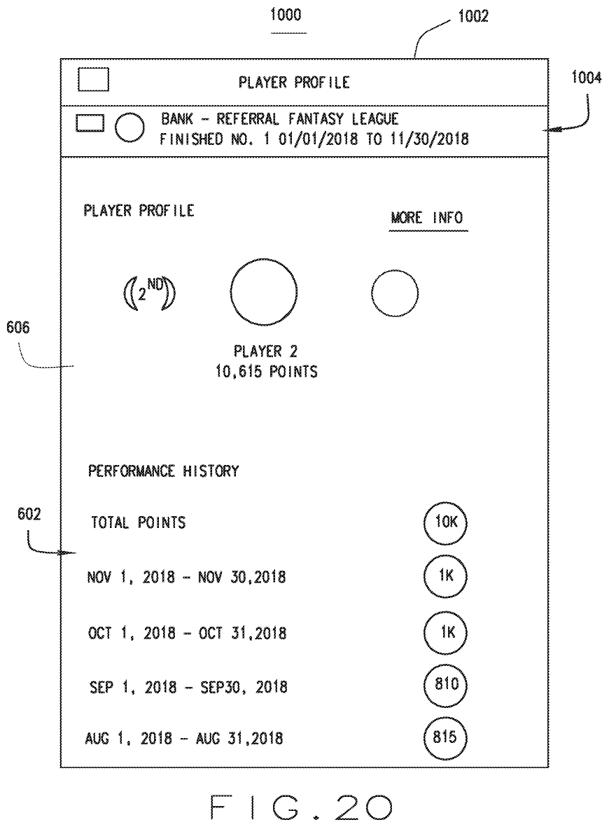

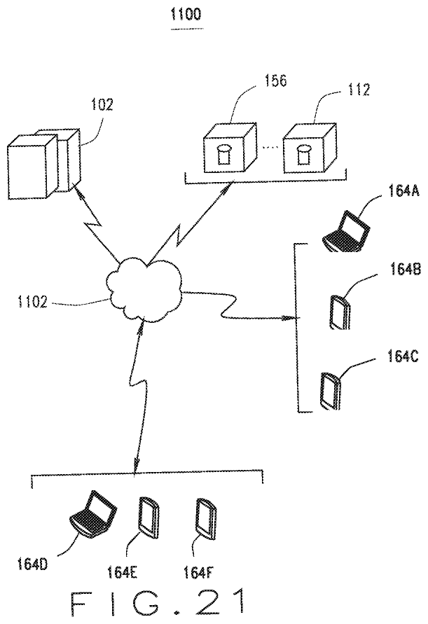

FIG. 20 is a mobile device 1002 with graphical user interface 1004 illustrating a player profile with player rank and points in window 606. Also shown is window 602 that shows the players performance history by date.

### Example: PFL Technical Solution to Diverse Company System

A company was in need of re-engaging company employees. After several successful years of employees referring new business opportunities, an organization may have plateaued. Employees continued to refer but the excitement level had peaked. With PFL, employees can be rejuvenated and excited to participate. Without any changes to the product set, or any additional product training, this organization saw over a 120% increase in the number of referral opportunities submitted over the same period the previous year. The number of new accounts grew by almost 70%, providing even more opportunities for cross-sales and revenue growth. PFL was a big win for the organization.

### Example: Merchant Service Company Employer

An exemplary company having over 3,000 employees decides to do a targeted campaign to increase referrals to their merchant card service provider. With this targeted campaign, they only included 20% of their workforce in the league, and participation did not slow them down, but rather to the contrary generated over 400% more referrals than the entire organization did in the same period the previous year. This company was proud and the merchant card service provider was ecstatic.

### Example: Restaurant League

The restaurant league can be configured for most points to win, with a league length of 2 months, with competition between two different locations of similar size or volume. The scoring can be established such as 1 point per $1 revenue, 150 points per appetizer, 300 points per dessert, 500 points per alcoholic beverage, and a prime cost goal (such a <65%) achieved.

### Example: Lender League

For a finance lender, the objective may be to increase revenue from net loan growth, and increase income from other lines of business. In such embodiment, the PFL can be set for loading COIs, prospects, top customer into pipeline with 10 points, each. Further sales calls completed can get 25 points, calls with comments 50 points, net loans booked S at 1 point per 51,000 by way of example, and referrals to other lines of business at 15 points per category.

### Example: Retail Company

For a retail company, a PFL can be established with an objective of deepening relationship with customers, increasing non-interest revenue and increasing core growth. This can include a retail sales plan with cross selling, referrals to other lines, employee's commission to points (PTR), and/or calls completed or meetings set. With such objectives, a league could be established, by way of one examples, so that the league is short (2 weeks to 3 months), with small teams (10 player max), with prizes being communicated before the league begins. The team can develop commitments and strategy to accomplish goals, with players setting personal commitments and goals. Teams can be selected using a “draft night” or day as a fun kickoff. The league would include tracking and communication among the diverse players on a team and can include team building weekly meetings. A prize scenario can include a league prize, with the top 3 teams receiving a reward, prizes based on ranking, with a league MVP getting rewarded. Further a stretch prize can be provided where a “stretch goal” is attained during the campaign and the prizes can be enhanced.

The PFL 100 can be configured to identify top performer players in a league for special and/or visible recognition. As can be understood from this description, an employee of an employer must participate as a player on a team in the league to be rewarded.

As noted above the PFL system and method can be implemented for access and user input and manipulation using a hosted webpage interface or via a mobile application that may be a thin app, or otherwise, as may be suitable for user interfacing. These include a home page or landing for a mobile device graphical user interface for a PFL system and method.

An example of a mobile device graphical user interface for a PFL system and method illustrating an employee/player's league information.

The system and method as described herein provides the functionality and presentation of the player, team and league functions and presentations of determined outputs such as the metrics and determined rewards using specialized computer software. The PFL system and method can provide numerous benefits to a company for which PFL leagues and teams are formed. These can include, by way of example and not limited thereto,

A. Team—Encouragement, encourage employee players by showing that their opinions count when working towards a common company goal;

B. Training/Development—Help to identify skills and resources needed to achieve goals and allows employee players to regularly learn and grow their skills;

C. New Management Tool—As PFL leagues simplify the reporting process and assigns a “point total” to players based on their accomplishments, managers and supervisors can more easily identify high and low performers and identify who is doing well and who is not, which can provide input and feedback to HR to identify employees who needs coaching and which players can share their best practices;

D. Builds Relationships—Improves teamwork by helping employee players develop deeper relationships with coworkers across organizations;

E. Increases Knowledge Transfer—Increases the knowledge of employees outside of their normal job function and can help employee players become experts in other areas of their organization through discussion with their teammates, and providing increased knowledge faster than the typical work setting;

F. Increases Accountability—Raises individual accountability when being part of a PFL team and teammates hold one another accountable (not reliant on organization management thereby raising the team accountability to the entire organization;

G. Increase Employee Performance—Increases employee performance through fun and friendly competition while focusing them on achieving organizational goals;

H. Provide Improved Administration—The PFL creates a fun, competitive environment that is easy to administer and track;

I. Improved Employee Creativity—The PFL encourages employee players to think creatively during the process of competing in league play and enables them to name their own team, come up with a personal nickname, and find the best way to reach stretch goals and score points;

J. Improves Communication—The PFL enhances communication between employee players, teammates, management and departments relating to company goals and objectives as each players knows exactly where they stand, where their team stands, and if the organization has reached its objective;

K. Improves Employee Participation and Engagement—The PFL increases employee player participation in company activities and behaviors aligned to objectives and goals;

L. Improves Employee Expectations—The PFL enables a company to clearly communicate expectations and organizational priorities and employee player to know what they need to do to help the organization reach its goal (weighted metrics);

M. Employee Rewards—Provides regular and systematic rewards to Employee Players and teams; and

N. Improved Employee Recognition—Provides consistent recognition of employee players for their performance.

### Implementation and Operational Environment for the PFL System and Method

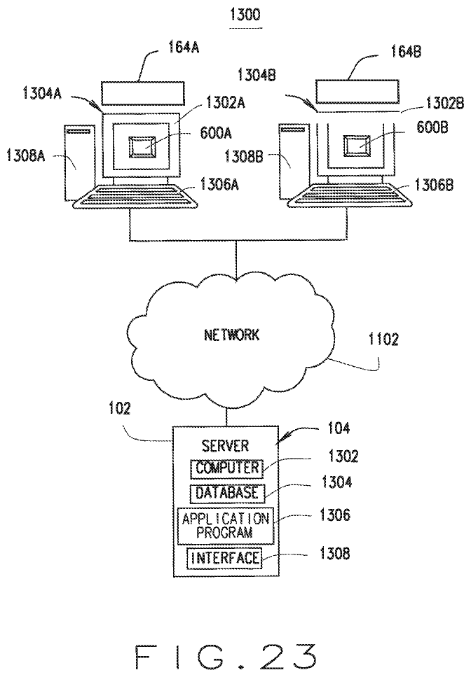

FIGS. 21, 22 and 23 illustrate exemplary embodiments of implementations of the system or server 102, 106 with the PFL system and software 104 installed thereon. Computer system 102 as shown in FIG. 1, and FIGS. 21, 22, and 23, and server 106 as shown in FIG. 4 include at least one user computing 164 operatively connected to at least one remote device 164 using a host server 160 through a communication network 1102 to communicate data between the user computing device 164 and the remote device host server 160. The systems 100, 150, 1100, 1200, and 1300 each provide varying descriptions of the computer and communications environment for various embodiments of the PFL system 100. The PFL server 160 that is specially configured for the PFL processes includes a computer 1302, a database 1304, a specialized PFL application program 1306 and an interface 1308, as shown in FIG. 23.

In an embodiment of FIG. 21, the embodiments of the user computing device 164 (shown as 164A, 164B, 164C, 164D, 164E and 164V) any electrical or electronic device capable of communicating with a remote device host server 160 through a communication network 1102, such as, for example, a cellular phone such as discussed above, a personal digital assistant (PDA), a telephone operating with an interactive voice-system, or a television operating with a cable or satellite television interactive system. As shown in FIG. 23, the user computing device 164 can also be a computer 164A, 164B, such as 1308A, 1308B, that includes a processor 1309, memory 1311, that may include transitory or non-transitory memory, a mass storage device 1313, a display device 1302A, 1302B, and an input device 1306A, 1306B, such as a keyboard, that is capable of running a network interfacing program 600A, 600B, such as web browser software available, for example, Chrome from Google® Corporation, Safari from Apple® Corporation, or Internet Explorer from Microsoft® Corporation, or an appropriate custom software application which implements at least some of the system 100 and method described above. The user computing device 164 can be appropriately equipped with a network interfacing device 160A, 160B, 160C, 160C 114, 128, 140 for communicating data with the communication network 126, such as a an interface to a cellular or mobile wireless network, dial-up modem, a cable modem, a satellite connection, a DSL (Digital Subscriber Line) connection, a LAN (Local Area Network), or the like.

As noted, the user computing device 164 includes an operating system configured to perform executable instructions. The operating system can include software, including programs and data, which manages the device's hardware and provides services for execution of software applications/modules. Those of skill in the art will recognize that suitable operating systems can include, by way of non-limiting examples, Apple OS, Microsoft Windows, Microsoft®, Windows®, Apple® Mac OS X®, UNIX®, and UNIX-like operating systems such as GNU/Linux®. In some embodiments, the operating system can be provided by cloud computing. Those of skill in the art will also recognize that suitable mobile smart phone operating systems include, by way of non-limiting examples, Nokia® Symbian®, OS, Apple® iOS®, Research In Motion® BlackBerry OS®, Google® Android®, Microsoft® Windows Phone®, OS, Microsoft® Windows Mobile®, OS, Linux®, and Palm WebOS®.

As noted, the user computing device 164 typically includes one or more memory device or storage devices that can include one or more transitory or non-transitory memory devices. The memory can store data including operating system, programs, applications, system user data, and application data on a temporary or permanent basis. In some embodiments, the memory can be volatile and requires power to maintain stored information but can also be non-volatile and retains stored information when the user computing device 164 is not powered. Further, the memory can be located with the user computing device 164 or can be attachable thereto either physically or via a data network connection to a remote memory.

The user computing device 164 can include a visual display as the user device display 164 of FIG. 23. In some embodiments, the display 1302 can be a cathode ray tube (CRT) or an optical projector, but is increasingly a flat screen such as a liquid crystal display (LCD), a plasma display, a thin film transistor liquid crystal display (TFT-LCD), a light emitting diode (LED) or an organic light emitting diode. In other embodiments, the display can also be a combination of devices such as those disclosed herein. Typically they are located proximate to the digital processing but in some embodiments, the display can be remotely located.

The user computing device 164 can also include one or more input devices or features. In some embodiments, the input device 1306 can be a keyboard or keypad but these can also include a pointing device such as, by way of non-limiting examples, a mouse, touchpad, light pen, pointing stick, trackball, track pad, joystick, game controller, stylus, touch screen, multi-touch screen, a microphone that captures voice or other sound inputs or an optical image capture device that can capture images or motion or other visual input. In still further embodiments, the input device can be a combination of devices such as those disclosed herein.

In accordance with the description provided herein, a suitable user computing device 164 can include, by way of example, server computers, desktop computers, laptop computers, notebook computers, tablet computers, mobile phones such as smart phones, audio devices, personal digital assistants, netbook computers, smart book computers, subnotebook computers, ultra-mobile PCs, handheld computers, Internet appliances, and video game systems both portable and fixed.

A system user 519 interacts with the user computing device 164 by viewing data via the display device 1302 and entering data via the input device 164, or other suitable input interface such as a mouse, microphone, touch screen, and the like.

In the exemplary embodiments of FIGS. 21, 22, and 23, the communication network 1102 can be a cellular or mobile wireless network or a WiFi™ network. A non-inclusive list of exemplary wireless protocols and technologies used by communication network 1102 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), packet switched core networks (PS-CN), and near field communications (NFC).

A mobile application, or app, executed by user computing device 114 can communicate with a remote device host server 112 via an Application Programming Interface (API) 154 (FIG. 4), such as Parse (http://www.parse.com), using the communication network 1102 using the Hypertext Transfer Protocol (HTTP). The API 154 can accept data from the user computing device 164 and send it to the remote device host server 112 which can process the information.

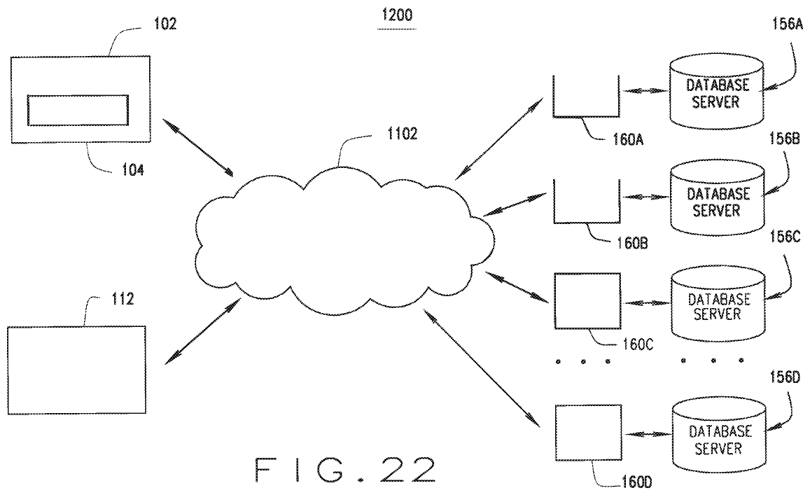

In an embodiment of FIGS. 21, 22, and 23, the communication network 1102 can be the Internet, which uses a suitable communications protocol, such as Hypertext Transfer Protocol (HTTP), to communicate data between the player-client devices 164, client devices 168 and third party systems 112 such as content database service servers 156A, 156B, 156C, and 156D of FIG. 22. These can include content services, social network services and third party database services, by way of examples. However, the communication network 1102 can be any network that enables an exchange of data between any of these identified devices, as well as other possible communication devices, services and services, and the remote device host server 112, such as 112A and 112B, of FIG. 2 and FIG. 22, such as a LAN or WAN (Wide Area Network). In addition, any suitable type of communications protocol can be used, such as FTP (File Transfer Protocol), SNMP (Simple Network Management Protocol), TELNET (Telephone Network), and the like. An exemplary non-inclusive list of primarily wireline protocols and technologies used by communication network 1102 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The network interfacing program enables the system user 164 to enter addresses of specific web pages to be retrieved, which are referred to as Uniform Resource Locators, or URLs. The web pages can contain various types of content from plain textual information to more complex multimedia and interactive content, such as software programs, graphics, audio signals, videos, and so forth. A set of interconnected web pages, usually including a homepage, are managed on a server device as a collection collectively referred to as a website. The content and operation of such websites are managed by the server device, such as remote device host server 160, which can be operatively connected to the communication network 126.

The remote device host server 112 or 156 preferably comprises a similar computer system as described above with regard to FIG. 23 and server 160. The web server applications are software running on the remote device host server 160 or in the “cloud” that make it possible for the client browsers to download stored web pages. These applications also coordinate streaming audio, video, and secure e-commerce, and can be integrated with databases for information retrieval. Examples of web server applications that can be used with the present invention include: Apache™, Microsoft's Internet Information Server (IIS)™, O'Reilly & Associates WebSite Pro™, Netscape's FastTrack Server™, and StarNine's WebSTAR™ (for Macintosh), although any operating systems known or anticipated can be used.

In one or more embodiments, the application servers can insert strings of programming code into the formatting and display language, with client browsers employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere™ although any application servers known or anticipated can be used.

In some embodiments, one or more of these operating environment systems as described herein, their platforms, the servers, the programs (computer executable instructions), and methods disclosed herein enable each to be a specialized PFL system providing the new and improved systems and processes as described herein and are not limiting in nature or as to technology for such implementations.

The database 156 can store device Ids (for Anonymous Users), player-client profiles and the other data as described herein. One skilled in the art will recognize that any particular piece of information can be stored in the database 156 located on the remote device host server or the local database located on the user computing device 114 without departing from the scope of the current disclosure.

In one or more embodiments, the DBMS can be an RDBMS that uses relational database to retrieve information from the system 100 and method database. In one or more embodiments, the relational database can use structured query language (SQL™), including SQL defined according to International Standards Organization (ISO) and American National Standards Institute (ANSI) standards, or follow these standards with additional language constructs. In one or more exemplary embodiments, an application on the remote device host server 112 can access a database via an application programming interface (API) 154, including for example the open database connectivity (ODBC™), Java database connectivity (JDBC™), APIs 154.

The previously described system 100 and method can be implemented as a series of interconnected web pages, or as a mobile app. As one skilled in the art will appreciate, the series of interconnected web pages or mobile app screens, portions thereof or data field or link contained therein, can be constructed from the information in the system 100 and method, as that information is described herein. The information can be used for simply display, can be shown as hyperlinks or other navigation controls, including but not limited to buttons, as is known in the art. The hyperlinks or other navigation controls can be used to link, provide data, or provide navigation between the individual pages or screens that make up the series of interconnected web pages or mobile app.

The manner of displaying the retrieved informational content in a web browser is primarily according to formatting and display languages. Examples of formatting and display languages that can be used with the present invention include Hyper Text Markup Language (HTML), eXtensible Markup Language (XML), eXtensible HyperText Markup Language (XHTML), and Cascading Style Sheets (CSS).

HTML can be used to create text files that contain markup tags, which inform the browser how to display the page. HTML files must have an “htm” or “html” file extension, and can be created using a simple text editor. XML can be a markup language that permits system users to define their own markup tags. The markup tags in XML are not predefined as with HTML. XML uses a Document Type Definition (DTD) or an XML Schema to describe the data. While HTML was designed to display data, focusing on how the data appears, looks, XML was designed to describe data, focusing on the data itself, providing the ability to structure, store, and to send information. XML can be pared-down version of Standard Generalized Markup Language (SGML), specifically designed for Web documents. SGML can be a comprehensive system for the client entity and tagging of document elements. Rather than specifying particular formatting, SGML specifies the rules for tagging elements. XHTML can be the same as a version of HTML referenced as HTML 4.01. It is HTML defined as an XML application and applies a strictly defined version of HTML. CSS can be used to design stylesheet pages, which define how the document is displayed or printed to the browser. CSS sheets can be attached to the HTML document itself. The cascading feature supported by CSS permits a single document to use two or more stylesheets, which are applied according to specified priorities.

The manner of formatting the information for retrieval from servers and transmitting the retrieved information over network are determined by protocols. A variety of protocols can be used to implement the present invention over the Internet, including the aforementioned HTTP, FTP, telnet, as well as, for example, Internet Relay Chat (IRC).

The main protocol (or set of rules for navigation and exchanging of files between clients and servers) used on the Web is HTTP, designed for exchanging files running on top of TCP/IP. HTTP not only defines how messages are formatted and transmitted, but also what actions Web server applications and browsers should take in response to various commands.

The act of using a client browser to download a Web page located at a server application can also be called navigating the Web, or browsing the Web, or linking to Web sites on the Web. Each Web page has a Web address called a Uniform Resource Locators (URLs). Consequently, Web pages are located by linking to the URL of a Web page and displaying it in the browser. System users 102 can link to Web pages by selecting or clicking on menu choices, highlighted words, or graphics associated with URLs. When a system user 102 enters a URL in his/her browser, or otherwise attempts to link to a website, it causes an HTTP command to be sent to the appropriate Web server, directing it to fetch and transmit the requested Web page.

If necessary to accommodate large amounts of information or run numerous applications, alternate embodiments of the remote device host server 112 can comprise multiple computer systems, multiple databases 156, or any combination thereof.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A system providing an integrated employee and employee-team performance management service, the system comprising:
a user resource manager (URM) resident on a computing device of a system user having a display, a processor, a non-transitory memory, computer executable instructions, and a communication interface and wherein the URM is configured from the computer executable instructions to include a plurality of resource modules providing a graphical interface in the form of URM pages displayed on the system user computing device display and on employee-player computing device displays, each computing device having a communications interface providing communications over a communications network to the communication device of each employee-players, the URM configured to include a plurality of teams assigned to a league, a team profile and a league profile, and having an employee-player profile for each employee-player, the URM also configured for having league defined reporting parameters and objective metric data, assignable points for at least some of the objective metric data, league defined employee-player team reward triggers, and predetermined performance rewards associated with each reward trigger, each employee-player being assigned to at least one team in the league and each employee-player profile including employee-player profile parameters and employee-player reward triggers, the URM also configured for
receiving league, team and employee profile input including at least one reward trigger and points assigned to at least some of the predetermined objective metric data;
receiving objective metric data from an external source that is associated with at least one of the employee-players;
assigning predetermined points to the received objective metric data;
providing league, team and employee-player profile page displays;
transmitting to a remote employee-player device each of the league, team and employee-player displays and reporting parameters, the received objective metric data and the assigned points associated with the received objective metric data;
comparing the received employee-player reporting data, assigning points to the reporting data;
summing the total assigned points for an employee-player or for a team of the player;
comparing the total assigned points to a predetermined reward trigger; and
generating a reward output message awarding a predetermined performance reward to a player or a team upon a successful comparing that determines that the summed points is equal to or greater than the predetermined reward trigger for the predetermined reward identified in the reward output message.

2. The system of claim 1 wherein the URM hosts a messaging interface enabling each employee-player to communicate with other employee-players on the same team through a messenger service.

3. The system of claim 1 wherein the URM is configured to include an application programming interface (API) for integrating or incorporating the functionality of a co-resident application or accessible application of the computing device selected from the group consisting of: a calendar, a web browser, a contact list, a directory, a telephone application, a text or multimedia application, a memory, a camera or video capture application, and email application, an alerting application, and the like.

4. The system of claim 1 wherein the system user is an employee of an employer and the employee-player is an employee of the employer, with each team being composed of employee-players that are across one or more organizations in within the employer entity, and wherein the computing device of a system user is an employer performance metrics tracking system and the received objective metrics data is performance criteria data that is predefined as an objective for all teams in the league.

5. The system of claim 1 wherein the URM is configured to enable a hosted professional fantasy league composed of employees of an employer and the objective metric data is selected consistent with the success objectives of the employer.

6. The system of claim 1 wherein the URM is configured for receiving league profile data including the identification of the teams in the league, the employee-player identifications, one or more dates related to the league, one or more objective criteria data, an allocation of points to at least some of the objective criteria data, one or more rewards, and a reward trigger defined by a point level for each of the rewards.

7. The system of claim 1 wherein the URM is configured for the comparing to include comparing the summed points for a first team to the summed points of a second team in the same league, wherein the award trigger is determination of the team having the most summed points.

8. The system of claim 1 further comprising the URM configured for receiving a points multiplier and after receipt thereof allocating the received points multiplier to a predetermined period of time for one or more objective metric data.

9. The system of claim 1 wherein the URM is configured to award points directly based on received predetermined point quantities, as received over the communications interface that were a one time manually input quantity as input by the system user during the period of a league's operations.

10. The system of claim 1 further comprising the URM being configured for determining of league visibility filters defining access rules to player and team data and intra-communications, including limiting or preventing access to and the displaying of player and team profile data to other teams within the league.

11. A method providing an employee team-based performance system to a plurality of employee user players (users), and having a plurality of performance teams within each of one or more performance leagues, the method comprising:
a) in a remote device having a employee-player user application interface communicatively interfacing to a plurality of remotely situated User Resource Manager (URM) applications, each being associated with a different employee-player user, and a content services interface configured for communicating with one or more content servers with each content server providing objective metric data associated with at least one of the employee players:
receiving at a system employee-player interface a plurality of employee-player reporting profiles for a particular employee-player user, the employee-player reporting profile being for a different employee-player previously selected by the employee-player user and having one or more employee-player reporting parameters including at least an assignment of the employee-player to one or more teams in a league;
receiving from the content server employee-player data associated with at least one of the employee-player reporting parameters of a particular one of the employee-players metric data identifying an activity or event having objective metric data associated with the particular employee-player and the team and league to which the employee-player is assigned; and
transmitting at least a portion of the received employee-player metric data to the URM with which the employee-player profile is associated; and
b) in the user resource manager (URM) resident on a computing device of each employee-player user having a display and a employee-player interface and being composed of a plurality of resource modules providing a graphical interface in the form of URM pages displayed on the employee-player user computing device display, the computing device having a communications interface providing communications over a communications network to a communication device of each employee-player selected by the employee-player user of the URM, the URM including the plurality of employee-player profiles with each employee-player profile being for one of the employee-players defined by the employee-player user and having one or more team parameters and one or more league parameters, with each league having one or more teams, and also having one or more employee-player parameters that includes one or more employee-player reporting parameters and one or more employee-player reward triggers:
providing a plurality of league page displays as a part of the displayed URM pages;
providing a plurality of team page displays as a part of the displayed URM pages, wherein the team page is a team to which the employee-player is a team member;
providing a plurality of employee-player profile page displays as a part of the displayed URM pages;
transmitting to the remote device at least a portion of the employee-player profile for each employee-player as the employee-player reporting profile including the one or more employee-player reporting parameters;
receiving the instant employee-player data from the remote device;
updating the employee-player profile with the instant employee-player data;
comparing the received instant employee-player data with an employee-player reward trigger defined in the employee-player profile;
detecting in near real time as a result of the comparing an occurrence of an reward event; and
generating an alert action to a component of the computing device of the employee-player user providing an indication on the computing device that the reward event was detected as a result of the detecting.

12. The method of claim 11 wherein in the URM hosting a messaging interface enabling each employee-player to communicate with other employee-players on the same team through a messenger service.

13. The method of claim 11 wherein in the URM integrating or incorporating via a configured application programming interface (API) a co-resident application or accessible application of the computing device selected from the group consisting of: a calendar, a web browser, a contact list, a directory, a telephone application, a text or multimedia application, a memory, a camera or video capture application, and email application, an alerting application, and the like.

14. The method of claim 11 wherein the system user is an employee of an employer and the employee-player is an employee of the employer, wherein the remote device comprises:
enabling the establishing of each team being composed of employee-players that are across one or more organizations in within the employer entity, wherein the remote device is an employer performance metrics tracking system with the receiving of the objective metrics data being the receiving of performance criteria data that is predefined as an objective for all teams in the league.

15. The method of claim 11 wherein in the remote device, further comprising:
hosting of a professional fantasy league composed of employees of an employer and the objective metric data is selected consistent with the success objectives of the employer.

16. The method of claim 11 wherein in the remote device, further comprising:
receiving league profile data including the identification of the teams in the league, the employee-player identifications, one or more dates related to the league, one or more objective criteria data, an allocation of points to at least some of the objective criteria data, one or more rewards, and a reward trigger defined by a point level for each of the rewards.

17. The method of claim 11 wherein in the URM the step of comparing includes comparing the summed points for a first team to the summed points of a second team in the same league, in the comparing the award trigger is a determining of the team having the most summed points.

18. The method of claim 11 wherein in the URM, further comprising:
receiving a points multiplier and after receipt thereof, allocating the received points multiplier to a predetermined period of time for one or more objective metric data.

19. The method of claim 11 wherein in the URM, further comprising
awarding points directly based on received predetermined point quantities, as received over the communications interface that were a one time manually input quantity as input by the system user during the period of a league's operations.

20. The method of claim 11, wherein in the URM, further comprising:
determining one or more league visibility filters with each configured for defining access rules to player and team data and intra-communications, including limiting or preventing access to and the displaying of player and team profile data to other teams within the league.
